(19) United States
(12) Patent Application Publication
(10) Pub. No.: US 2018/0253708 A1
(43) Pub. Date: Sep. 6, 2018

(54) CHECKOUT ASSISTANCE SYSTEM AND CHECKOUT ASSISTANCE METHOD

(71) Applicant: FUJITSU LIMITED, Kawasaki-shi (JP)

(72) Inventors: Jaikrishna MOHANAKRISHNAN, Kawasaki (JP); Akinori TAGUCHI, Kawasaki (JP)

(73) Assignee: FUJITSU LIMITED, Kawasaki-shi (JP)

(21) Appl. No.: 15/972,349

(22) Filed: May 7, 2018

Related U.S. Application Data
(63) Continuation of application No. PCT/JP2015/082165, filed on Nov. 16, 2015.

(51) Int. Cl. G06Q 20/18; G06Q 30/06

(52) U.S. Cl. CPC G06Q 20/18; G06Q 30/0601

(57) ABSTRACT

A processor detects a direction of a line of sight from an image picked up by a camera, refers to position information of an item stored in a memory, and identifies one or a plurality of items that correspond to the detected direction of the line of sight. The display displays the one or the plurality of items identified by the processor, in such a manner that such an item or items can be selected as an item candidate for a checkout target.

### CROSS-REFERENCE TO RELATED APPLICATION

This application is a continuation application of International Application PCT/JP2015/082165 filed on Nov. 16, 2015 and designated the U.S., the entire contents of which are incorporated herein by reference.

### FIELD

The embodiments discussed herein are related to a checkout assistance system and a checkout assistance method.

### BACKGROUND

In recent years, retail stores such as a supermarket have introduced automated checkout machines called a self-checkout system in order to reduce labor costs related to store clerks who manipulate Point Of Sale (POS) registers or to reduce waiting time for POS registers. In a self-checkout system, a customer uses a barcode reader to scan a barcode pasted on an item that he or she purchases, and thereby can make a checkout for the item by himself or herself.

However, among items that are sold, there are many items on which barcodes are not pasted such as perishables including vegetables, fruit, etc. In such a case, a customer manually inputs, to the self-checkout system, information such as an item code, which serves in place of a barcode, and thereby can make a checkout for an item not having a barcode.

A technique is also known in which the user selects an image, displayed on a screen, corresponding to an item not having a barcode or an item having an exterior feature close to an image obtained by picking up an image of an item is displayed as a candidate (see Patent Document 1 and Patent Document 2 for example). A technique is also known in which a state in which a customer accesses an item stored in a shelf is determined or people are categorized into a group on the basis of the positional relationships with each other of the people detected from a video image (see Patent Document 3 and Patent Document 4 for example).
Patent Document 1: Japanese National Publication of International Patent Application No. 2005-526323
Patent Document 2: Japanese Laid-open Patent Publication No. 2002-074511
Patent Document 3: Japanese Laid-open Patent Publication No. 2009-048430
Patent Document 4: Japanese Laid-open Patent Publication No. 2006-092396

### SUMMARY

According to an aspect of the embodiments, a checkout assistance system includes a camera, a processor and a display.

The processor detects a direction of a line of sight from an image picked up by the camera, refers to position information of an item stored in a memory, and identifies one or a plurality of items that correspond to the detected direction of the line of sight. The display displays the one or the plurality of items identified by the processor in such a manner that the one or the plurality of items can be selected as an item candidate for a checkout target.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional configuration diagram of a checkout assistance system;

FIG. 2 is a functional configuration diagram illustrating a first specific example of the checkout assistance system;

FIG. 3 is a configuration diagram of a self-checkout system to which the first example of the checkout assistance system is applied;

FIG. 4 illustrates line-of-sight information, item position information and carrying tool position information stored in a storage unit;

FIG. 5 illustrates feature amount information;

FIG. 6 illustrates first line-of-sight information;

FIG. 7 illustrates item position information;

FIG. 8 illustrates carrying tool position information;

FIG. 9 illustrates candidate information;

FIG. 10 illustrates a rule;

FIG. 11 illustrates item information;

FIG. 12 illustrates a selection result;

FIG. 13 illustrates a checkout screen;

FIG. 14 is a flowchart illustrating a candidate generation process;

FIG. 15 is a flowchart illustrating a customer detection process;

FIG. 16 is a flowchart illustrating a first shopping ID setting process;

FIG. 17 is a flowchart illustrating a first checkout target identification process;

FIG. 18 is a flowchart illustrating a cart position identification process;

FIG. 19 is a flowchart illustrating a candidate presentation process;

FIG. 20 is a flowchart illustrating a first shopping ID identification process;

FIG. 21 is a flowchart illustrating a first checkout target item determination process;

FIG. 22 is a flowchart illustrating a first checkout process;

FIG. 23 is a functional configuration diagram illustrating a second specific example of the checkout assistance system;

FIG. 24 is a first configuration diagram of a self-checkout system to which the second specific example of the checkout assistance system is applied;

FIG. 25 illustrates second line-of-sight information;

FIG. 26 is a flowchart illustrating a second shopping ID setting process;

FIG. 27 is a flowchart illustrating a second checkout target identification process;

FIG. 28 is a flowchart illustrating a second shopping ID identification process;

FIG. 29 is a second configuration diagram of a self-checkout system to which the second specific example of the checkout assistance system is applied;

FIG. 30 illustrates third line-of-sight information;

FIG. 31 is a flowchart illustrating a third checkout target identification process;

FIG. 32 is a third configuration diagram of a self-checkout system to which the second specific example of the checkout assistance system is applied;

FIG. 33 illustrates line-of-sight information, item position information and weight information stored in the storage unit;

FIG. 34 illustrates first weight information;

FIG. 35 is a flowchart illustrating a fourth checkout target identification process;

FIG. 36 is a flowchart illustrating a second checkout process;

FIG. 37 illustrates second weight information;

FIG. 38 is a flowchart illustrating a returned item detection process;

FIG. 39 is a functional configuration diagram illustrating a third specific example of the checkout assistance system;

FIG. 40 is a configuration diagram of a self-checkout system to which the third specific example of the checkout assistance system is applied;

FIG. 41 illustrates fourth line-of-sight information;

FIG. 42 illustrates flow line information;

FIG. 43 is a flowchart illustrating a flow line generation process;

FIG. 44 is a flowchart illustrating a third shopping ID setting process;

FIG. 45 is a flowchart illustrating a third shopping ID identification process; and

FIG. 46 is a configuration diagram of an information processing apparatus.

### DESCRIPTION OF EMBODIMENTS

Hereinafter, detailed explanations will be given for the embodiments by referring to the drawings.

When a customer selects an item not having a barcode as a checkout target from a list that includes all the items sold in the store in order to make a checkout for that item in a self-checkout system, he or she often performs a plurality of manipulations to identify that one item. These manipulations include for example a manipulation of switching between a plurality of screens sequentially, a manipulation of selecting the category of an item, and other manipulations. Performing a plurality of manipulations each time one item is identified as described above makes checkout operations complicated.

Also, items that a customer is highly likely to purchase may be displayed as candidates on the basis of the purchase history of that customer. However, because a customer does not always purchase the same items, it is difficult to accurately predict, only from the purchase history, an item that the customer selected as a purchase target. Accordingly, when a customer purchases an item that is not included in the history, he or she is to select the item as a checkout target in a list including all the items and checkout operations are complicated.

Note that this problem arises not only in a self-checkout system but also in a case when a store clerk manipulates a POS register to select an item as a checkout target.

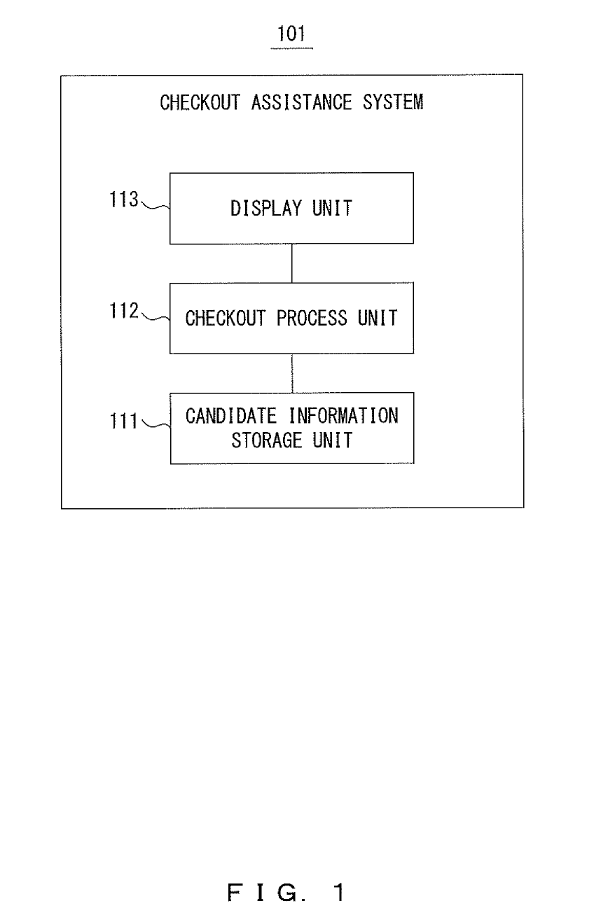

FIG. 1 illustrates a functional configuration example of a checkout assistance system according to an embodiment. A checkout assistance system 101 illustrated in FIG. 1 includes a candidate information storage unit 111, a checkout process unit 112 and a display unit 113. The candidate information storage unit 111 stores candidate information, which associates an item identified on the basis of the gaze position of a customer with identification information for the checkout for the customer, the item being one of the items sold in the store and the gaze position being detected from an image picked up by an image pickup device in the store.

When performing a checkout for the customer, the checkout process unit 112 extracts the identified item from the candidate information on the basis of the identification information for the checkout for the customer. The display unit 113 displays the information of the item extracted by the checkout process unit 112 in a state in which the information of the item can be selected as a checkout target.

A checkout assistance system such as this can improve the efficiency of manipulations, performed for a checkout for a customer, of selecting an item as a checkout target from among items sold in the store.

In supermarkets, when a customer puts, into the shopping basket, an item that he or she selected as a purchase target, he or she often gazes at that item displayed on a shelf before picking up that item with hand to put it into the shopping basket. The inventors have found that an item in a shopping basket is highly likely to be an item that a customer gazed at and was put into the shopping basket by the customer.

Identifying an item that a customer gazed at and preferentially displaying the information of that item on the selection screen of the checkout apparatus makes it possible for the customer to select an item as a checkout target easily, leading to reduced loads of selection manipulations. When for example item A is displayed on the first page of the selection screen for a checkout for a customer who gazed at item A on the shelf, the customer can select item A without switching to the next page.

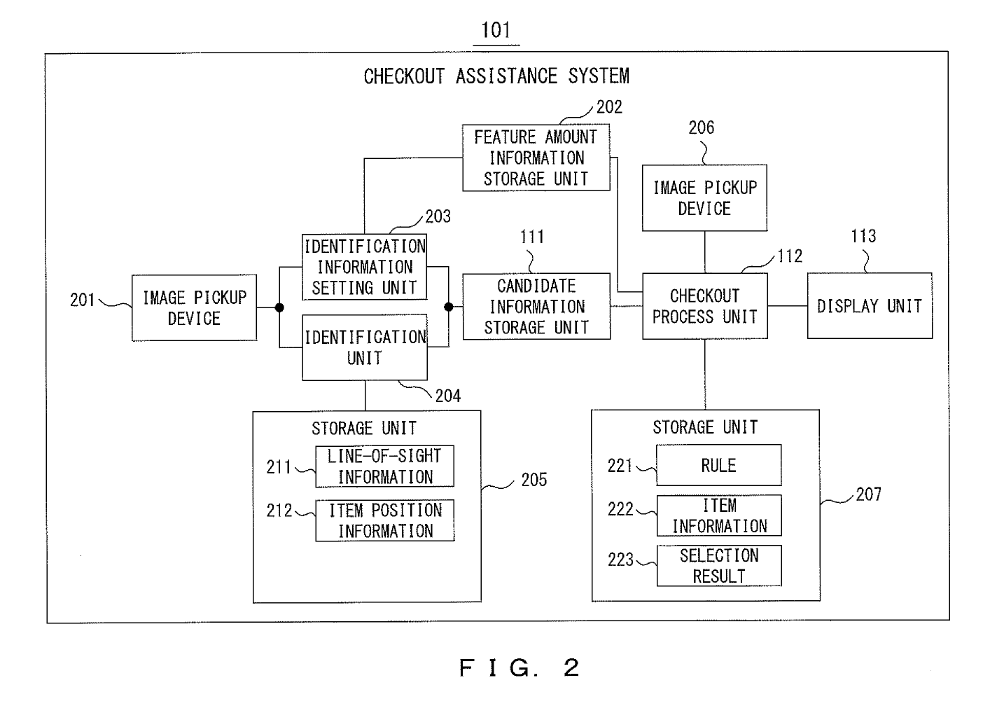

FIG. 2 illustrates a first specific example of the checkout assistance system 101 illustrated in FIG. 1. The checkout assistance system 101 illustrated in FIG. 2 includes the candidate information storage unit 111, the checkout process unit 112, the display unit 113, an image pickup device 201, a feature amount information storage unit 202, an identification information setting unit 203, an identification unit 204, a storage unit 205, an image pickup device 206 and a storage unit 207.

The image pickup device 201 is provided to a shelf that displays an item in the store and picks up an image of a customer who has come in front of the shelf. The feature amount information storage unit 202 stores feature amount information, which associates feature amounts of a plurality of customers with a plurality of pieces of identification information, the feature amounts being extracted from images picked up by the image pickup device 201 and the identification information being for the checkout for each of the plurality of customers. The identification information setting unit 203 sets, in candidate information stored in the candidate information storage unit 111, identification information associated with the feature amount of a particular customer by the feature amount information as the identification information for the checkout for that customer.

The storage unit 205 stores line-of-sight information 211 and item position information 212. The line-of-sight information 211 is information representing the gaze position indicated by the line of sight of the customer who has come in front of the shelf, and the item position information 212 is information for associating items sold in the store and the positions of those items in the store. The identification unit 204 detects the line of sight of the customer from the image picked up by the image pickup device 201, and generates the line-of-sight information 211. Also, the identification unit 204 identifies, on the basis of a result of a comparison between the gaze position indicated by the detected line of sight and the item position information 212, an item that the customer has selected as a purchase target, and associates the identification information set in the candidate information with the identified item.

The customer carries an item that he or she selected, by using a carrying tool such as a shopping basket, a cart, a tray, his or her own hand, etc. to a checkout apparatus. The image pickup device 201 may be provided to a carrying tool. The image pickup device 206 is installed around a checkout apparatus that performs a checkout for an item, and picks up an image of a customer who has come in front of the checkout apparatus. The checkout process unit 112 detects a customer from an image picked up by the image pickup device 206.

The storage unit 207 stores a rule 221, item information 222, and a selection result 223. The rule 221 is information specifying a determination criterion for determining the order of displaying items as checkout targets, the item information 222 is information representing the price of the item, and the selection result 223 is information representing an item that has undergone a checkout and the amount of money for that item.

In accordance with the determination criterion specified by the rule 221, the checkout process unit 112 displays the information of an item included in the candidate information on a screen of the display unit 113 in a state in which the information can be selected, obtains the price of an item selected by the customer from the item information 222, and registers the price in the selection result 223. Then, the checkout process unit 112 displays, on the screen, the total amount of money for all the items registered in the selection result 223 as the amount of money for the checkout. Thereby, the customer can make a checkout for the items as purchase targets so as to purchase the items.

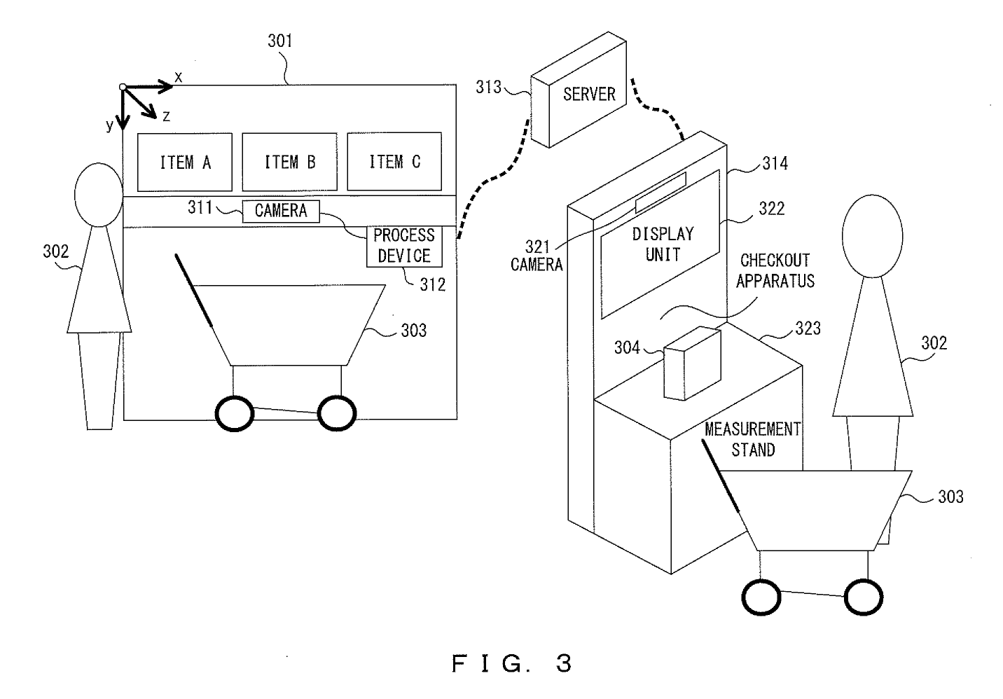

FIG. 3 illustrates a configuration example of a self-checkout system to which the checkout assistance system 101 in FIG. 2 is applied. The self-checkout system illustrated in FIG. 3 includes a camera 311, a process device 312, a server 313 and a checkout apparatus 314, and the checkout apparatus 314 includes a camera 321, a display unit (a display) 322 and a measurement stand 323. The store is provided with at least one shelf 301, and the camera 311 and the process device 312 are provided to the shelf 301. The server 313 can communicate with the process device 312 and the checkout apparatus 314 via a wired or wireless communication network.

The camera 311 and the camera 321 respectively correspond to the image pickup device 201 and the image pickup device 206 illustrated in FIG. 2. The camera 311 may be a stereo camera, and examples of thereof may include an infrared camera and a visible light camera that are used as a line-of-sight sensor.

The identification information setting unit 203, the identification unit 204 and the storage unit 205 illustrated in FIG. 2 are provided in the process device 312, the server 313 or the checkout apparatus 314. In such a case, these constituents may be provided in the process device 312, the server 313 and the checkout apparatus 314 in a distributed manner or may be concentrated in one of these devices. The checkout process unit 112 and the storage unit 207 are provided in the checkout apparatus 314, and the display unit 322 corresponds to the display unit 113. The feature amount information storage unit 202 and the candidate information storage unit 111 are provided in the process device 312, the server 313 or the checkout apparatus 314.

When the identification information setting unit 203 and the feature amount information storage unit 202 are provided in different devices, the identification information setting unit 203 accesses the feature amount information storage unit 202 via a communication network. When the identification information setting unit 203 and the candidate information storage unit 111 are provided in different devices, the identification information setting unit 203 accesses the candidate information storage unit 111 via a communication network.

When the identification unit 204 and the candidate information storage unit 111 are provided in different devices, the identification unit 204 accesses the candidate information storage unit 111 via a communication network. When the identification unit 204 and the storage unit 205 are provided in different devices, the identification unit 204 accesses the storage unit 205 via a communication network.

When the checkout process unit 112 and the feature amount information storage unit 202 are provided in different devices, the checkout process unit 112 accesses the feature amount information storage unit 202 via a communication network. When the checkout process unit 112 and the candidate information storage unit 111 are provided in different devices, the checkout process unit 112 accesses the candidate information storage unit 111 via a communication network.

A plurality of items including item A, item B and item C are displayed on the shelf 301. A customer 302 moves while pushing a cart 303 in the store, selects an item as a purchase target from the shelf 301 to put it into the cart 303, and carries the item to the checkout apparatus 314. Then, the customer 302 takes an item 304 from the cart 303, puts it on the measurement stand 323 of the checkout apparatus 314, and makes a checkout in accordance with guidance displayed on a screen of the display unit 322. The measurement stand 323 can measure the weight of the item 304.

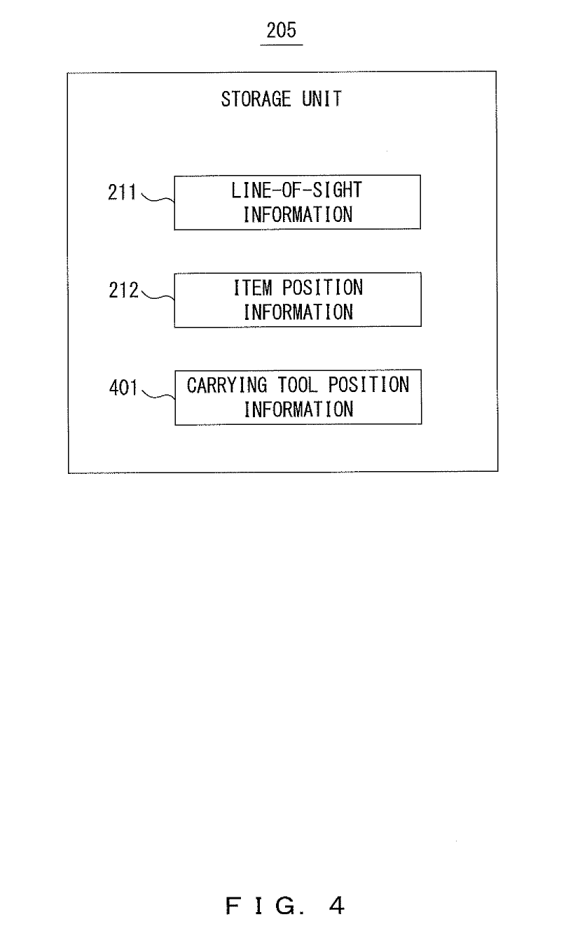

FIG. 4 illustrates an example of information stored by the storage unit 205 in the self-checkout system illustrated in FIG. 3. In this example, the storage unit 205 stores the line-of-sight information 211, the item position information 212 and carrying tool position information 401. The carrying tool position information 401 is information representing the position of the cart 303.

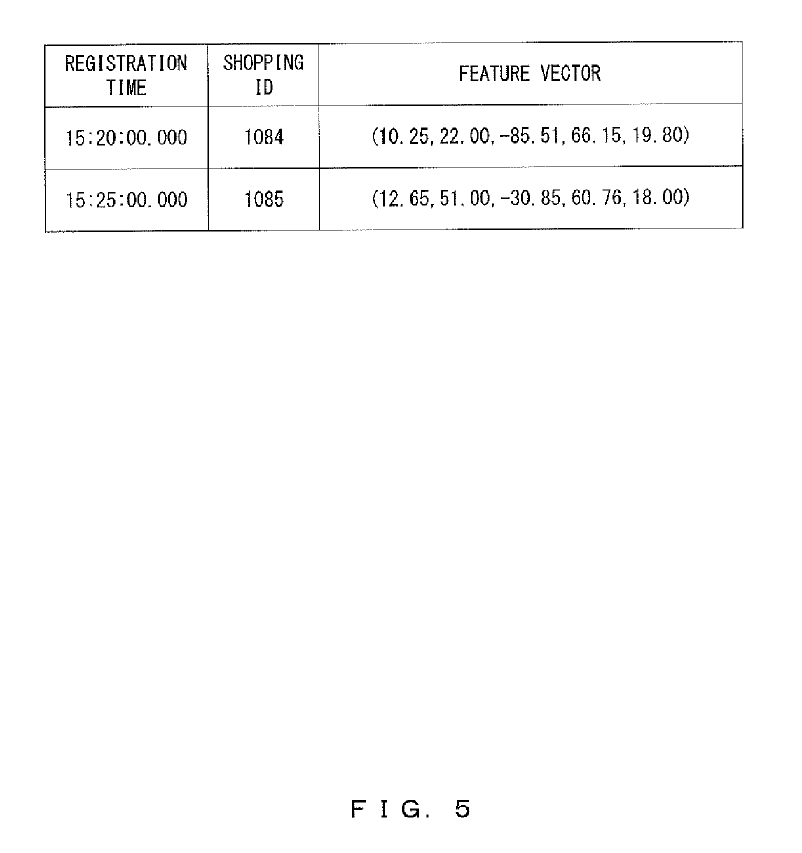

FIG. 5 illustrates an example of feature amount information stored in the feature amount information storage unit 202. Each record in feature amount information includes registration time, a shopping ID and a feature vector. Registration time represents the time at which the record was registered, and a shopping ID represents identification information for a checkout for the customer 302.

A feature vector is a feature amount extracted from an image of the customer 302 picked up by the camera 311, and represents for example a feature of the face of the customer 302. A feature of a face may be a relative positional relationship between a plurality of parts such as the eyes, the nose, the mouth, the ears, etc. For example, the feature vector of the customer 302 corresponding to the shopping ID “1084” registered at 15:20:00.000 (hh:mm:ss) for example is (10.25, 22.00, −85.51, 66.15, 19.80).

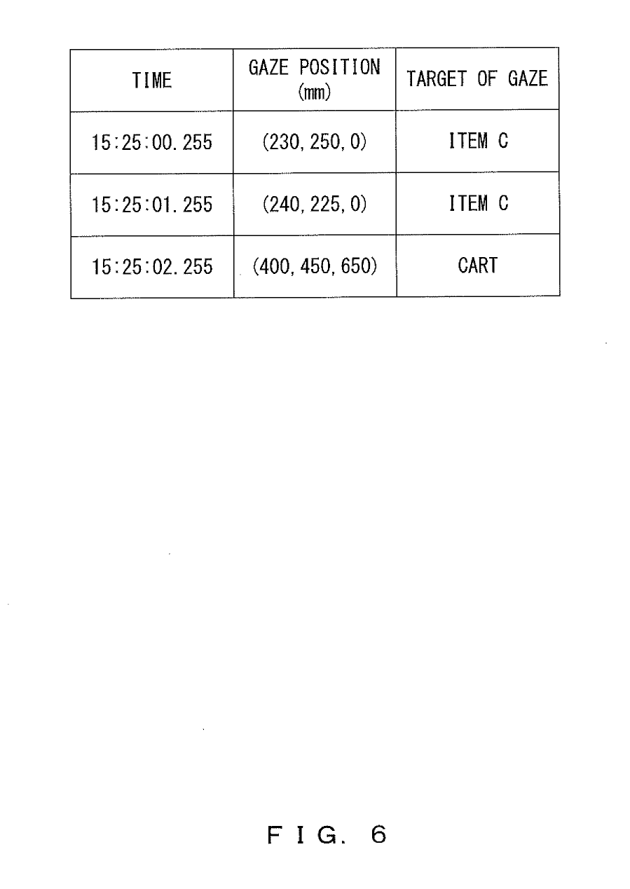

FIG. 6 illustrates an example of the line-of-sight information 211. Each record of the line-of-sight information 211 includes time, a gaze position and a target of gaze. Time represents the time at which the line of sight was detected from an image of the customer 302 picked up by the camera 311, a gaze position represents the gaze position indicated by the detected line of sight, and the target of gaze represents an object existing at the gaze position.

In this example, a gaze position is expressed by using an xyz coordinate system having its origin at the upper left corner of the front plane of the shelf 301 as illustrated in FIG. 3. The x axis represents the horizontal directions, the y axis represents the vertical directions, the z axis represents the depth directions, and each coordinate value represents a distance in units of mm. In this case, the xy plane corresponds to the front plane of the shelf 301, the x coordinate and the y coordinate of the area in which an item is displayed are 0 mm or longer, and the z coordinate of the area is 0 mm or shorter.

The line of sight of each of the right and left eyes of the customer 302 is represented by a three-dimensional line-of-sight vector in the xyz coordinate system. Accordingly, the intersection of the straight line represented by the line-of-sight vector of the left eye and the straight line represented by the line-of-sight vector of the right eye can be obtained as the gaze position of the customer 302.

For example, the gaze position at 15:25:00.255 is (x, y, z)=(230, 250, 0), which represents the position that is apart from the origin by 230 mm and 250 mm respectively in the positive directions of the x and y axes on the front plane of the shelf 301. Item C is displayed at this position. Also, the gaze position at 15:25:02.255 is (x, y, z)=(400, 450, 650), which represents a position closer to the customer than is the front plane of the shelf 301. The cart 303 is at this position.

The gaze position may be obtained by using a method other than the method in which the intersection of the straight lines represented by the line-of-sight vectors of eyes is obtained, and the gaze position may be a position represented in a two-dimensional coordinate system.

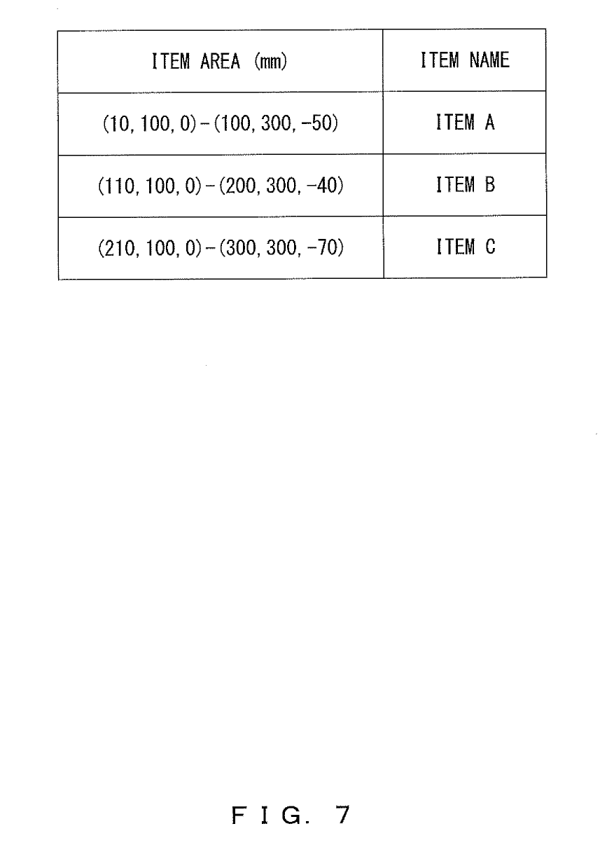

FIG. 7 illustrates an example of the item position information 212. Each record of the item position information 212 includes an item area and an item name. An item area represents an area in which a particular item exists on the shelf 301, and an item name represents the identification information of that item. An item area has a shape of a cuboid, and is represented by using an xyz coordinate system similarly to the case in FIG. 6. For example, item A exists in the area of the cuboid defined by the two vertexes of the upper left vertex on the front plane (10, 100, 0) and the lower right vertex on back plane (100, 300, −50). The segment connecting these vertexes corresponds to a diagonal line of the cuboid.

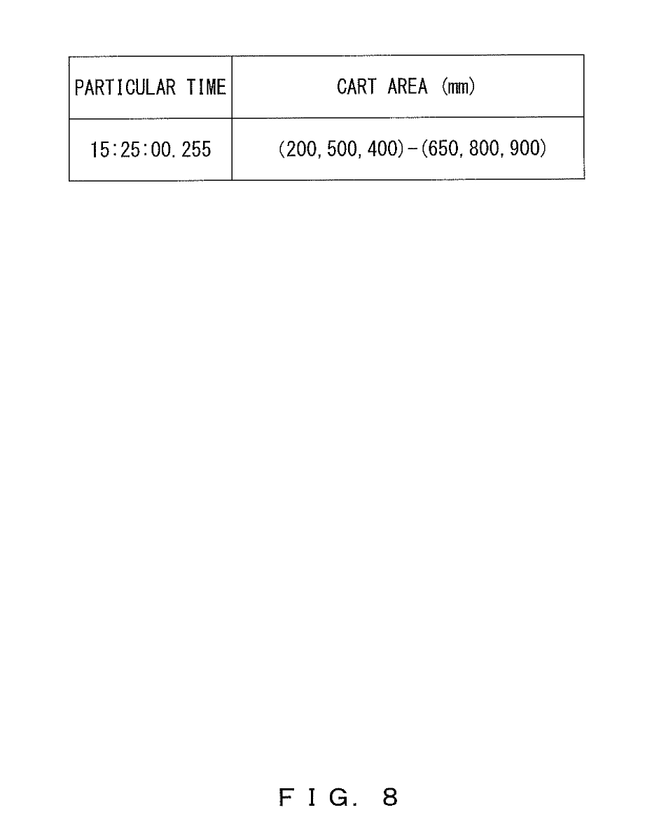

FIG. 8 illustrates an example of the carrying tool position information 401. A record of the carrying tool position information 401 includes particular time and cart area. Particular time represents the time at which the position of the cart 303 was identified from an image of the cart 303 picked up by the camera 311, and a cart area represents the area in which the cart 303 exists.

A cart area has a shape of a cuboid, and is represented by using an xyz coordinate system similarly to the case in FIG. 6. In this example, the cart 303 exists in the area of the cuboid represented by the two vertexes of (200, 500, 400) and (650, 800, 900) at 15:25:00.255. The segment connecting these vertexes corresponds to a diagonal line of the cuboid.

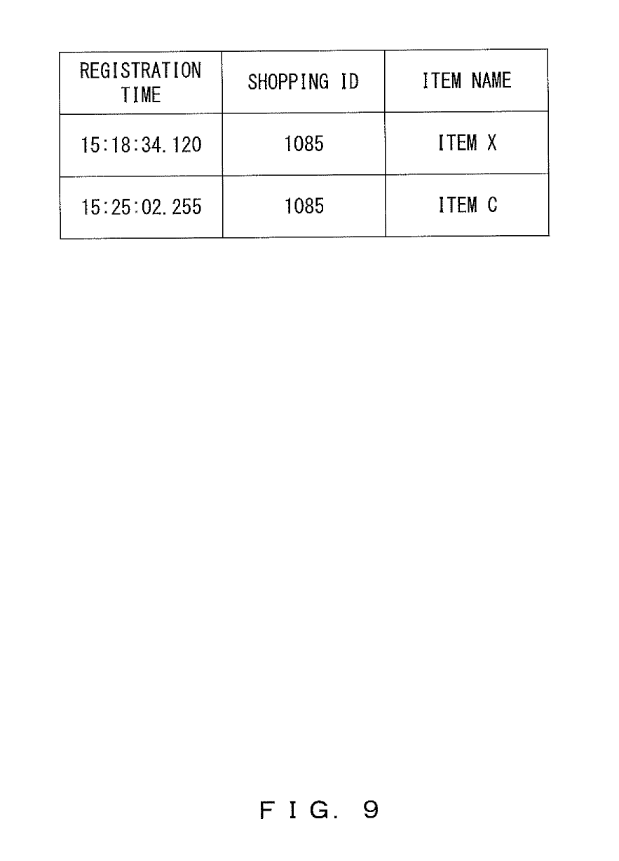

FIG. 9 illustrates an example of candidate information stored by the candidate information storage unit 111. Each record of candidate information includes registration time, a shopping ID and an item name. Registration time represents the time at which the record was registered. The item registered at 15:18:34.120 in association with the shopping ID “1085” for example is item X. Item X represents for example an item selected from a shelf different from the shelf 301. Also, the item registered at 15:25:02.255 in association with the same shopping ID “1085” is item C.

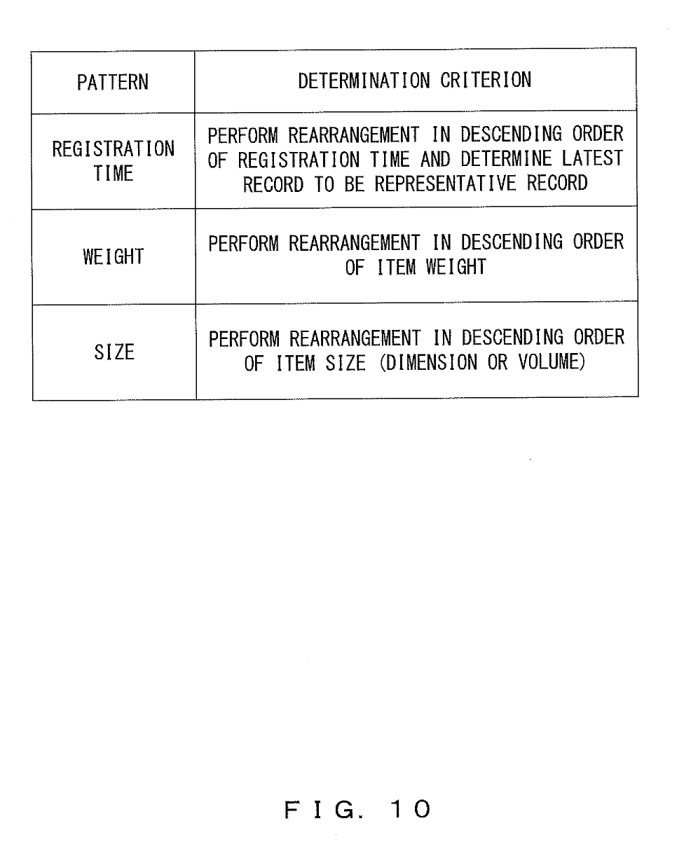

FIG. 10 illustrates an example of the rule 221. Each record of the rule 221 includes a pattern and a determination criterion. A pattern represents an attribute used for rearranging records of candidate information, and a determination criterion represents a method of rearranging records of candidate information.

When for example “registration time” is used, the checkout process unit 112 rearranges the records in descending order of registration time, i.e., in the order starting from the latest time. When there are a plurality of records having the same item name, the checkout process unit 112 determines, to be the representative record, the record with the latest registration time from among such records.

It is considered that when the customer 302 takes items from the cart 303 for making a checkout, he or she often takes items starting from those close to upper layers of the items and puts the items on the measurement stand 323. It is thus desirable on the screen that items closer to upper layers be able to be selected preferentially over those close to the bottom of the cart 303. By rearranging records in descending order of registration time, the items are displayed on the screen in such a manner that the later an item was put into the cart 303, the more priorly it is displayed. Thereby, the information of an item that the customer 302 highly likely put on the measurement stand 323 is priorly displayed as an option for a checkout target, leading to the reduction in the loads of selection manipulations.

Also, when “weight” is used, the checkout process unit 112 rearranges the records in descending order of item weight. After making a checkout for items, the customer 302 sequentially puts those items into his or her shopping bag in such a manner that heavier items are put into the bag first, and thus it is considered that he or she often takes items sequentially from the cart 303 starting from heavier items to put the items on the measurement stand 323. Thus, it is desirable that a heavier item be able to be selected preferentially over a lighter item on the screen. By rearranging records in descending order of item weight, the items are displayed in such a manner that the heavier an item is, the more priorly it is displayed on the screen. Thereby, the information of an item that the customer 302 highly likely put on the measurement stand 323 is priorly displayed as an option for a checkout target, leading to the reduction in the loads of selection manipulations.

When “size” is used, the checkout process unit 112 rearranges the records in descending order of item size (dimension or volume). After making a checkout for items, the customer 302 sequentially puts those items into his or her shopping bag in such a manner that larger items are put into the bag first, and thus it is considered that he or she often takes items sequentially from the cart 303 starting from larger items to put the items on the measurement stand 323. It is thus desirable on the screen that a larger item be able to be selected preferentially over a smaller item. By rearranging records in descending order of item size, the items are displayed on the screen in such a manner that the larger an item is, the more priorly it is displayed. Thereby, the information of an item that the customer 302 highly likely put on the measurement stand 323 is priorly displayed as an option for a checkout target, leading to the reduction in the loads of selection manipulations.

Note that the checkout process unit 112 may rearrange records on the basis of a combination between “registration time”, “weight” and “size”. For example, the checkout process unit 112 may rearrange records in descending order of item weight and rearrange the records of a plurality of items having an identical weight in descending order of registration time. Also, the checkout process unit 112 may rearrange records in descending order of item size and rearrange the records of a plurality of items having an identical size in descending order of registration time.

Other attributes such as the fragility of an item, whether or not an item is flat in shape, etc. may be used as a pattern.

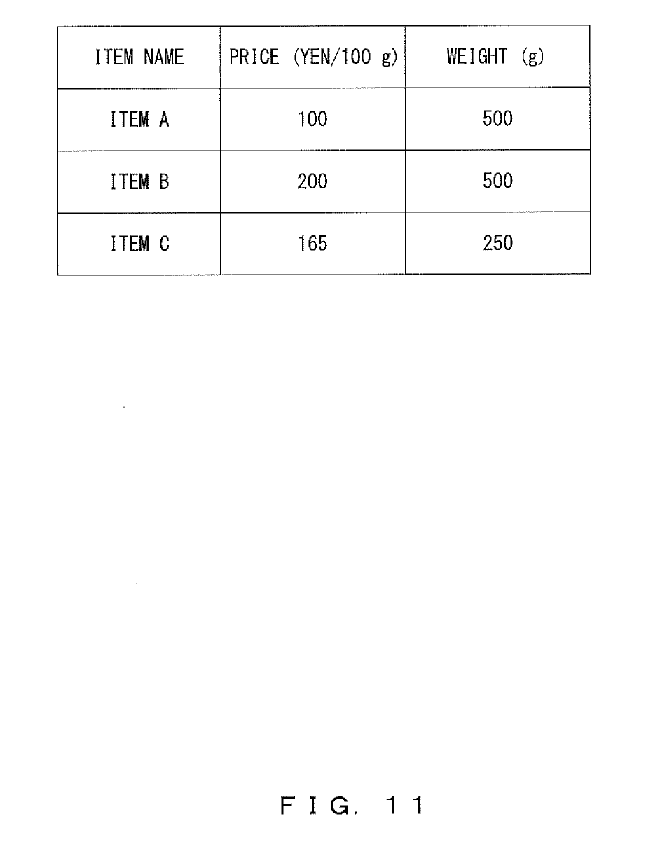

FIG. 11 illustrates an example of the item information 222. Each record of the item information 222 includes an item name, a price and a weight, and is set by the store in advance. A price represents the price per unit weight of the item, and a weight represents the standard weight of the item. When items are perishables such as vegetables, fruit, etc., such items are often sold in a state in which they are packed in a bag or in a package for each fixed weight. This fixed weight is used as a standard weight. For example, the price per 100 g of item A is 100 yen, and the standard weight of item A is 500 g. In such a case, the amount of money for item A is 500 yen.

When records of candidate information are rearranged in descending order of item size, each record of the item information 222 may include item size.

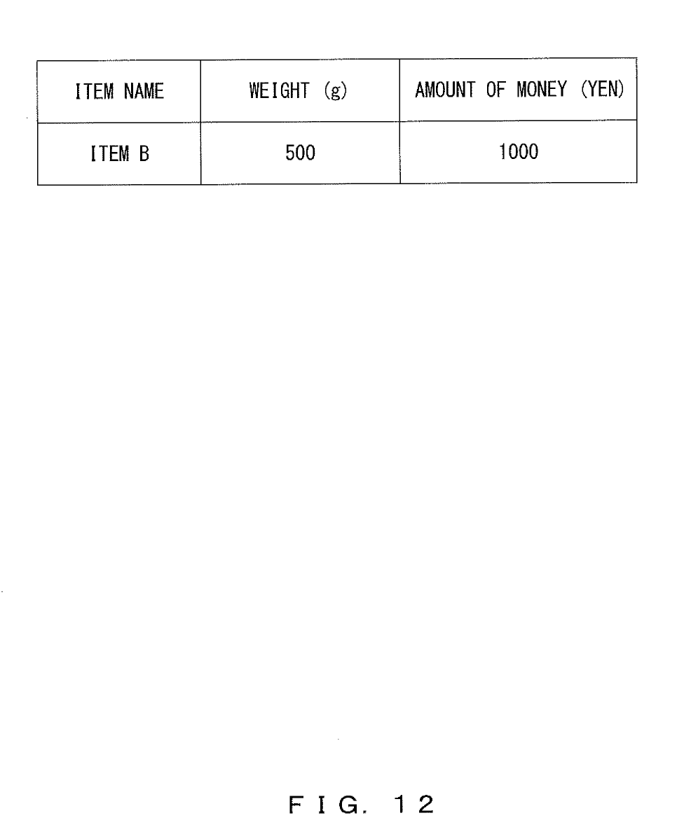

FIG. 12 illustrates an example of the selection result 223. Each record of the selection result 223 includes an item name, a weight and an amount of money. An amount of money is calculated by multiplying the standard weight of the item by the price per unit weight of the item. For example, the price per 100 g of item B is 200 yen, and the standard weight of item B is 500 g. In such a case, the amount of money for item B is 1000 yen.

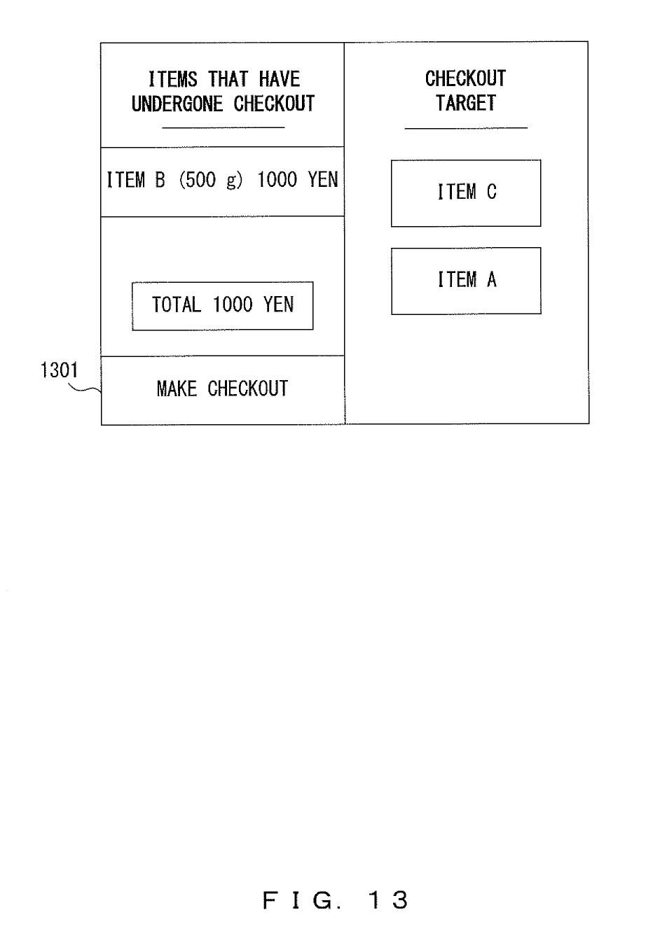

FIG. 13 illustrates an example of a checkout screen that is displayed on the display unit 322 on the basis of the selection result 223. In this example, the item names of items A and C are displayed as checkout target items, and item B is displayed as an item that has undergone a checkout. The total amount of money for items that have undergone a checkout is 1000 yen. When the customer 302 selects one of the checkout target items, the item name of the selected item is deleted from among the checkout target items, and is added to items that have undergone a checkout, and the amount of money for that item is added to the total amount of money. Also, when the customer 302 touches a button 1301 of “MAKE CHECKOUT”, the total amount of money is settled as the final amount of money for the checkout.

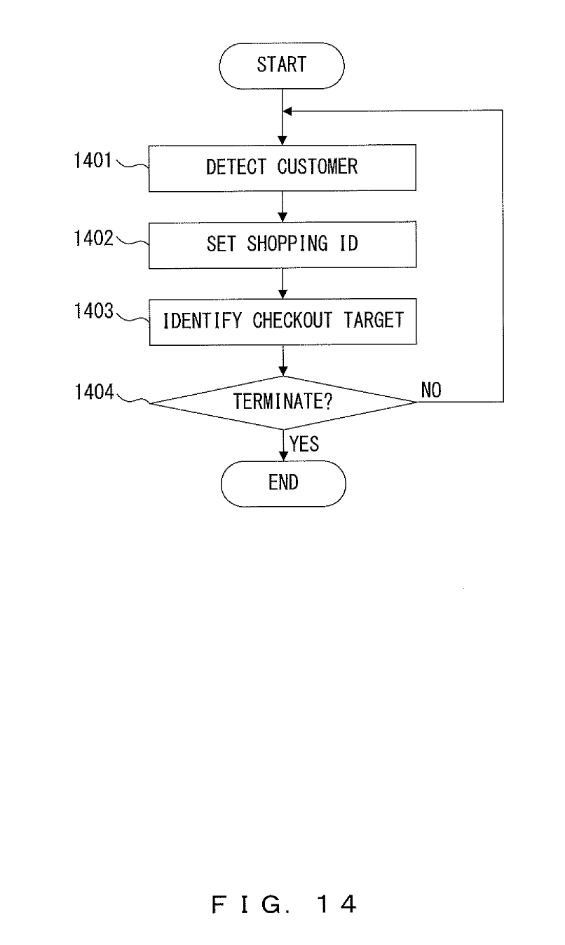

FIG. 14 is a flowchart illustrating an example of a candidate generation process performed in the self-checkout system illustrated in FIG. 3. First, the identification information setting unit 203 detects the customer 302 from an image picked up by the camera 311 (step 1401), and sets a shopping ID in the candidate information (step 1402).

Next, the identification unit 204 identifies an item selected by the customer 302 as a purchase target, and associates the identified item with the shopping ID in the candidate information (step 1403). Then, the identification information setting unit 203 determines whether or not to terminate the candidate generation process (step 1404).

When the candidate generation process is not to be terminated (NO in step 1404), the identification information setting unit 203 repeats the processes in and subsequent to step 1401, and when the candidate generation process is to be terminated (YES in step 1404), the identification information setting unit 203 terminates the process. The identification information setting unit 203 may terminate the candidate generation process when for example detecting a termination instruction input from the administrator.

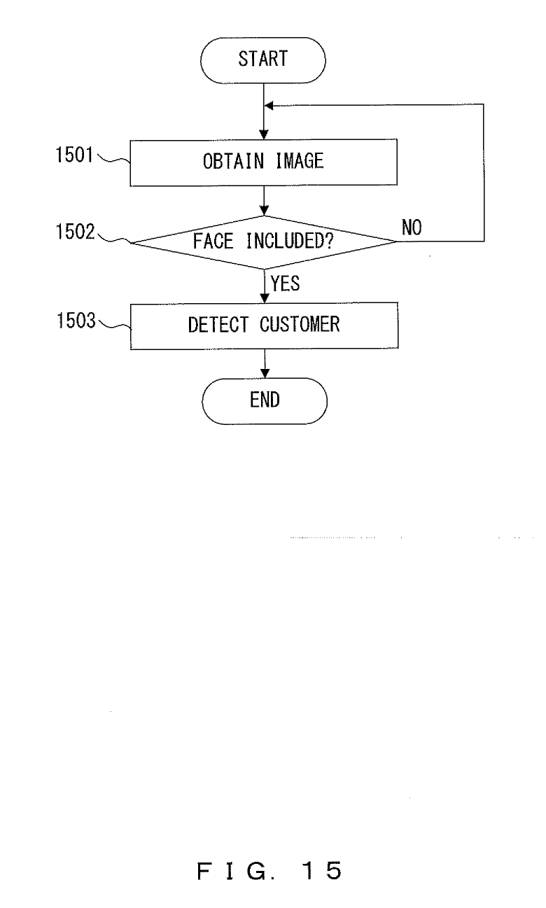

FIG. 15 is a flowchart illustrating an example of the customer detection process in step 1401 in FIG. 14. First, the identification information setting unit 203 obtains an image picked up by the camera 311 (step 1501), performs a face detection process, and checks whether or not the image includes a human face (step 1502). When the image includes a face (YES in step 1502), the identification information setting unit 203 detects that the customer 302 has come in front of the shelf 301 (step 1503). When the image does not include a face (NO in step 1502), the identification information setting unit 203 repeats the processes in and subsequent to step 1501.

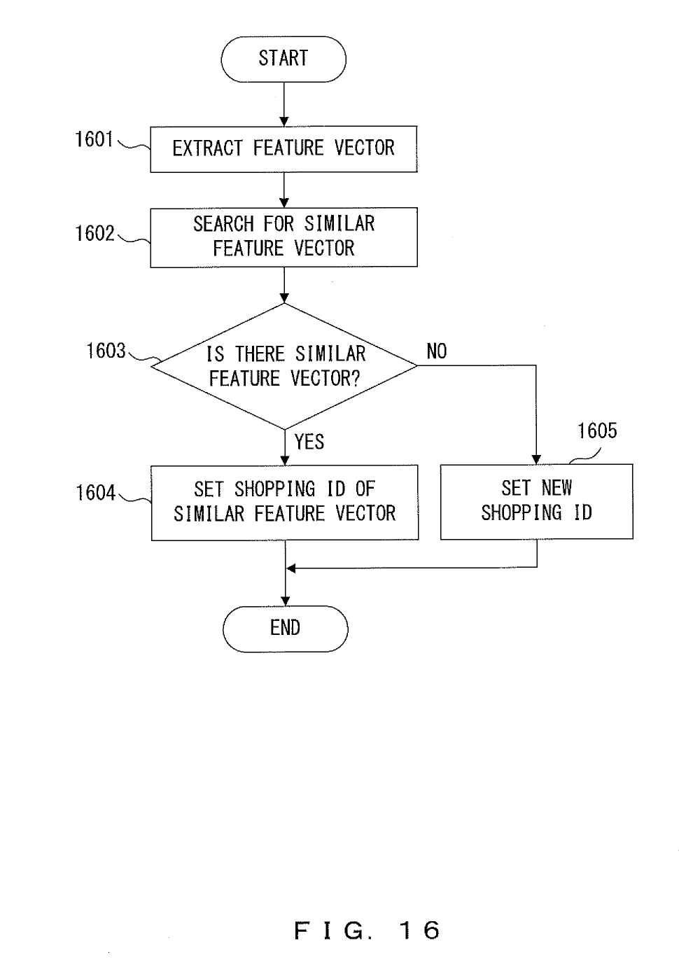

FIG. 16 is a flowchart illustrating an example of the shopping ID setting process in step 1402 in FIG. 14. First, the identification information setting unit 203 extracts a feature vector of the face of the customer 302 from the image picked up by the camera 311 (step 1601). Next, the identification information setting unit 203 searches records of feature amount information stored in the feature amount information storage unit 202 in order to detect a feature vector that is similar to the extracted feature vector (step 1602). Then, the identification information setting unit 203 checks whether or not records of feature amount information registered in a past prescribed period of time include a similar feature vector (step 1603).

When for example the length of a difference vector, which represents a difference between two feature vectors, is smaller than a threshold, the identification information setting unit 203 can determine that these two feature vectors are similar to each other. When the length of a difference vector is equal to or greater than a threshold, the identification information setting unit 203 determines that these feature vectors are not similar to each other. The past prescribed period of time may be an average cycle in which the customer 302 puts an item into the cart 303 or may be a period of time that ranges approximately between one minute and several minutes.

When the records in the past prescribed period of time include a similar feature vector (YES in step 1603), the identification information setting unit 203 generates a new record of candidate information and stores the record in the candidate information storage unit 111 (step 1604). Then, the identification information setting unit 203 obtains the shopping ID that is associated with the similar feature vector, from the retrieved record of the feature amount information, and sets the shopping ID in the generated record of the candidate information.

When the records in the past prescribed period of time does not include a similar feature vector (NO in step 1603), the identification information setting unit 203 generates a new shopping ID (step 1605). Thereafter, the identification information setting unit 203 generates a record of feature amount information that associates the current time, the generated shopping ID and the extracted feature vector with each other, and stores the record in the feature amount information storage unit 202. Also, the identification information setting unit 203 generates a new record of candidate information to store the record in the candidate information storage unit 111, and sets the generated shopping ID in that record.

According to a shopping ID setting process such as this, a new shopping ID is generated when the customer 302 who entered the store comes in front of the first the shelf 301, and a record of the feature amount information corresponding to that customer 302 is stored in the feature amount information storage unit 202. Thereafter, each time a record of candidate information is generated accompanying the movement of that customer 302, the shopping ID that was generated first is set in the record of the candidate information.

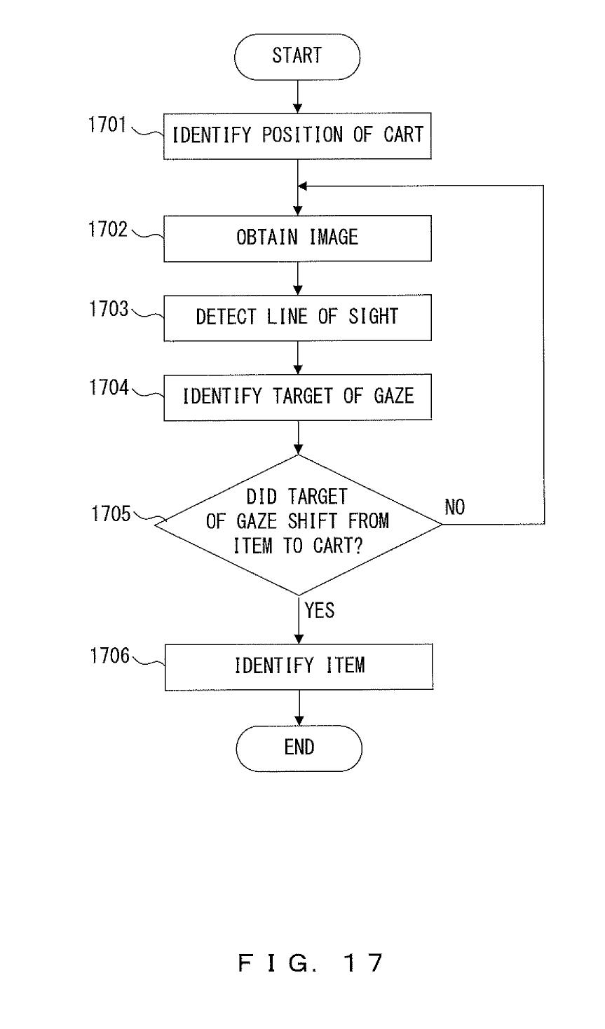

FIG. 17 is a flowchart illustrating an example of the checkout target identification process in step 1403 in FIG. 14. First, the identification unit 204 identifies the position of the cart 303, and generates the carrying tool position information 401 (step 1701).

Next, the identification unit 204 obtains an image picked up by the camera 311 (step 1702). Then, the identification unit 204 detects the line of sight of the customer 302 from the obtained image, and detects the gaze position specified by the line of sight on the basis of the detected line of sight (step 1703).

Next, the identification unit 204 compares the gaze position specified by the line of sight, the item position information 212 and the carrying tool position information 401, and identifies the target of gaze that corresponds to the gaze position (step 1704). Then, the identification unit 204 generates a record of the line-of-sight information 211 that associates the current time, the gaze position and the identified target of gaze with each other, and stores the record in the storage unit 205.

When for example the item area of one of the items specified by the item position information 212 includes the gaze position, the item name of that item is set in the record of the line-of-sight information 211 as a target of gaze. Also, when a cart area specified by the carrying tool position information 401 includes the gaze position, the cart 303 is set in the record of the line-of-sight information 211 as a target of gaze. When the gaze position is neither included in an item area nor the cart area, the fact that it is not possible to identify the target of gaze is recorded in the record of the line-of-sight information 211.

Next, on the basis of the line-of-sight information 211, the identification unit 204 checks whether or not the target of gaze shifted from an item to the cart 303 in a past prescribed period of time (step 1705). When for example the target of gaze specified by the record of the line-of-sight information 211 at the current time is the cart 303 and the target of gaze specified by the record at certain time in the past prescribed period of time is item C, it is determined that the target of gaze shifted from item C to the cart 303. The past prescribed period of time may be an average period of time that elapses between when the customer 302 gazes at an item on the shelf 301 and when he or she puts the item into the cart 303 or may be a period of time that ranges approximately between one second and several seconds.

When the target of gaze did not shift from an item to the cart 303 in the past prescribed period of time (NO in step 1705), the identification unit 204 repeats the processes in and subsequent to step 1702. When the target of gaze shifted from an item to the cart 303 in the past prescribed period of time (YES in step 1705), the identification unit 204 identifies that item as an item selected by the customer 302 as a purchase target (step 1706). Then, the identification unit 204 associates the current time and the item name of the identified item with the shopping ID set by the identification information setting unit 203, and sets these pieces of information in the record of the candidate information generated by the identification information setting unit 203.

In the line-of-sight information 211 illustrated in FIG. 6, the target of gaze at 15:25:01.255 is item C, and the target of gaze at 15:25:02.255 is the cart 303. When the past prescribed period of time is three seconds for example, it means that the target of gaze shifted from item C to the cart 303 within the prescribed period of time. Accordingly, item C is identified, and 15:25:02.255 and item C are associated with the shopping ID “1085”, and these pieces of information are set in the record of the candidate information.

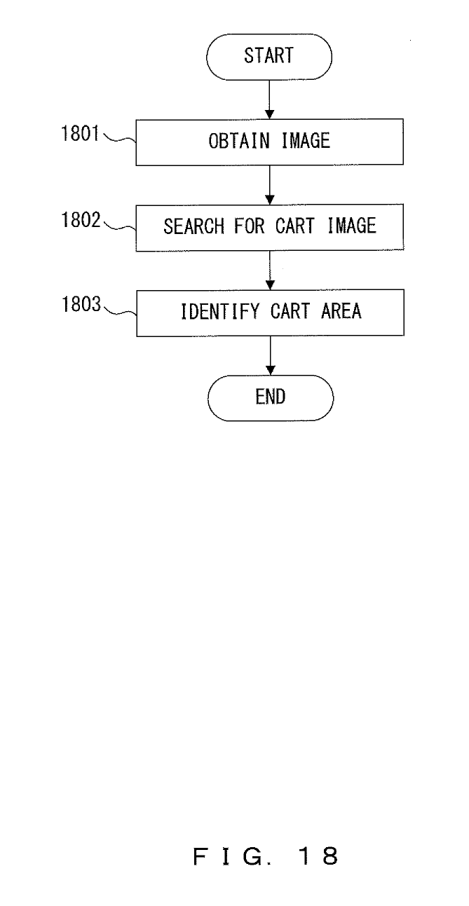

FIG. 18 is a flowchart illustrating an example of the cart position identification process in step 1701 in FIG. 17. First, the identification unit 204 obtains an image picked up by the camera 311 (step 1801), and searches the obtained image for a cart image, which represents the shape of the cart 303 (step 1802). As a cart image, for example an image of the cart 303 that is picked up by the camera 311 in advance may be used.

Next, the identification unit 204 converts an area corresponding to a cart image for which the search was conducted into a cart area in the xyz coordinate system, generates a record of the carrying tool position information 401 that associates the current time with the cart area, and stores the record in the storage unit 205 (step 1803).

It is considered that the customer 302 often gazes at an item before putting that item into the cart 303 and often gazes at the cart 303 when putting an item into the cart 303. According to the checkout target identification process in FIG. 17, when the customer 302 gazes at the cart 303 within a prescribed period of time after gazing at an item, that item is included in the candidate information as a checkout target. This makes it possible to generate candidate information including an item that the customer 302 highly likely put into the cart 303.

In step 1705 in FIG. 17, the identification unit 204 may check whether or not the target of gaze is fixed to the same item for a prescribed period of time instead of checking whether or not the target of gaze shifted from an item to the cart 303 in a past prescribed period of time. When for example the target of gaze specified by a record of the line-of-sight information 211 at the current time is item C and the targets of gaze specified by all the records in the past prescribed period of time are also item C, it is determined that the target of gaze is fixed to item C.

When the target of gaze is not fixed to the same item for a prescribed period of time, the identification unit 204 repeats the processes in and subsequent to step 1702, and when the target of gaze is fixed to the same item for a prescribed period of time, the identification unit 204 identifies that item as an item selected by the customer 302 as a purchase target.

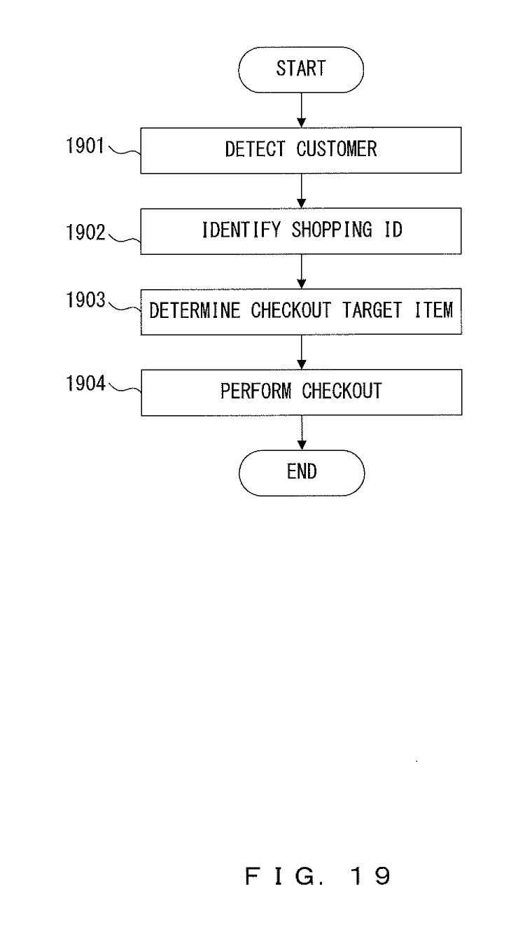

FIG. 19 is a flowchart illustrating an example of a candidate presentation process in the self-checkout system illustrated in FIG. 3. First, the checkout process unit 112 detects the customer 302 from an image obtained by the camera 321 (step 1901), and identifies the shopping ID (step 1902). The customer detection process in step 1901 is similar to that in FIG. 15. Next, the checkout process unit 112 determines a checkout target item for the customer 302 on the basis of the candidate information (step 1903), and performs a checkout while presenting a checkout target item to the customer 302 (step 1904).

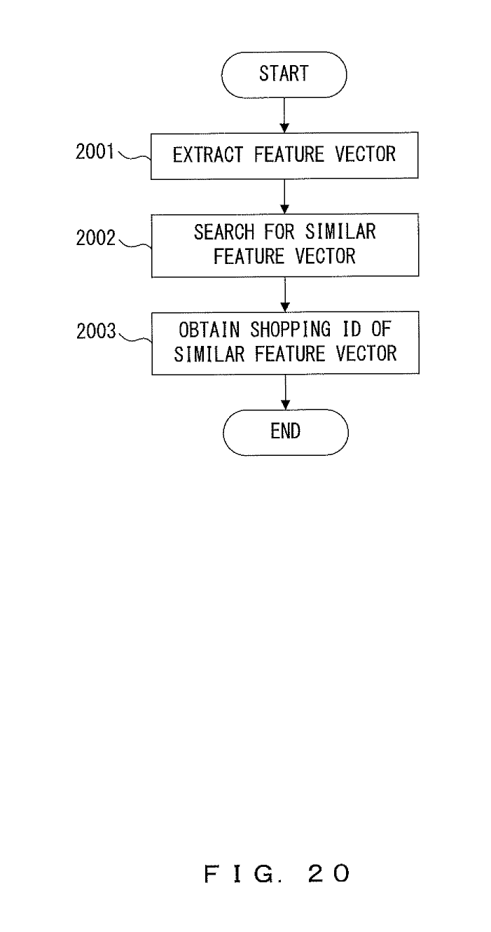

FIG. 20 is a flowchart illustrating an example of the shopping ID identification process in step 1902 in FIG. 19. First, the checkout process unit 112 extracts a feature vector of the face of the customer 302 from an image picked up by the camera 321 (step 2001). Next, the checkout process unit 112 searches feature amount information for a feature vector similar to the extracted feature vector (step 2002), the feature amount information being stored in the feature amount information storage unit 202. Then, the checkout process unit 112 obtains the shopping ID that is associated with the similar feature vector from the record of feature amount information for which the search was conducted (step 2003).

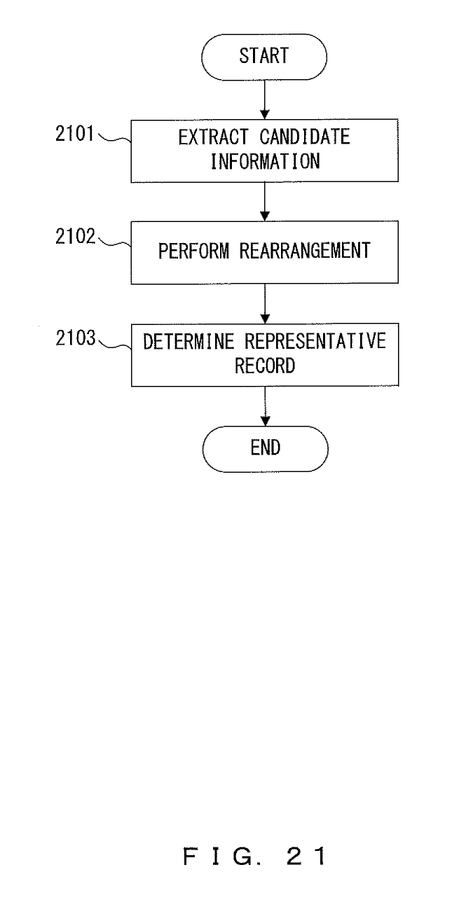

FIG. 21 is a flowchart illustrating an example of the checkout target item determination process in step 1903 in FIG. 19. First, the checkout process unit 112 extracts a record including the obtained shopping ID from among records of candidate information stored in the candidate information storage unit 111 (step 2101). Next, the checkout process unit 112 rearranges the extracted records in accordance with the determination criterion specified by the rule 221 (step 2102), and determines a representative record (step 2103).

When for example there are a plurality of records having different registration times for item C, the checkout process unit 112 may determine, to be the representative record of item C, the record having the latest registration time from among those records. The checkout process unit 112 may determine, to be the representative record, the record having the earliest registration time instead of the record having the latest registration time.

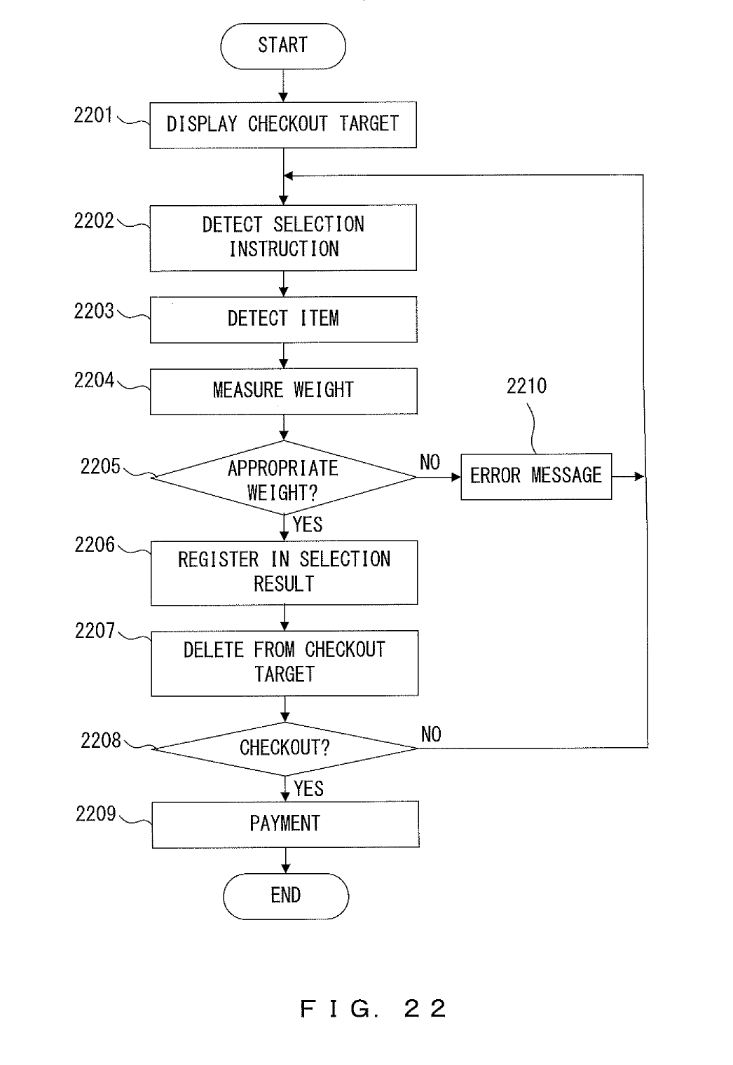

FIG. 22 is a flowchart illustrating an example of the checkout process in step 1904 in FIG. 19. First, the checkout process unit 112 extracts the item names included in the representative records of the respective items, and displays the extracted item names on the screen of the display unit 322 in accordance with the order of the rearranged records (step 2201). Thereby, the item names of items that the customer 302 highly likely put into the cart 303 are displayed as an option for a checkout target.

Next, the checkout process unit 112 detects a selection instruction input by the customer 302 (step 2202), and detects that an item has been put on the measurement stand 323 by the customer 302 (step 2203). When for example the measurement result indicated by the measurement stand 323 is not zero, the checkout process unit 112 may determine that an item has been put on the measurement stand 323.

Next, the measurement stand 323 measures the item weight, and the checkout process unit 112 obtains the measurement result (step 2204). Then, the checkout process unit 112 checks whether or not an appropriate weight is presented as the measurement result (step 2205).

The checkout process unit 112 obtains from the item information 222 the weight of an item specified by a selection instruction, and can determine that an appropriate weight is presented as the measurement result when the difference between the obtained weight and the measurement result is equal to or smaller than a threshold. When the difference between the obtained weight and the measurement result is greater than the threshold, the checkout process unit 112 determines that an appropriate weight is not presented as the measurement result.

When for example an item selected by the customer 302 is not identical to an item that the customer 302 put on the measurement stand 323, the difference becomes greater than the threshold, leading to a determination that an appropriate weight is not presented as the measurement result. When an appropriate weight is not presented as the measurement result (NO in step 2205), the checkout process unit 112 displays an error message (step 2210), and repeats the processes in and subsequent to step 2202.

When an appropriate weight is presented as the measurement result (YES in step 2205), the checkout process unit 112 generates a record of the selection result 223 including the item name of an item specified by the selection instruction, the weight and the amount of money, and stores the record in the storage unit 207 (step 2206). In this process, the checkout process unit 112 can calculate the amount of money by obtaining the price and weight of the item specified by the selection instruction from the item information 222 and multiplying the price by the weight.

Next, the checkout process unit 112 deletes the item name of the item specified by the selection instruction from the options displayed for checkout targets (step 2207). Then, the checkout process unit 112 displays the deleted item name as an item that has undergone a checkout, adds the amount of money of that item to the displayed total amount of money, and updates the display of the total amount of money.

Next, the checkout process unit 112 checks whether or not a checkout instruction has been input by the customer 302 (step 2208). For example, when the customer 302 touches the button 1301 in FIG. 13, a checkout instruction is input. When a checkout instruction has not been input (NO in step 2208), the checkout process unit 112 repeats the process in and subsequent to step 2202.

When a checkout instruction has been input (YES in step 2208), the checkout process unit 112 displays a message that requests the payment of the total amount of money (step 2209). In response to this, the customer 302 makes payment and purchases items.

When there are a plurality of the same items in the cart 303, the customer 302 in step 2202 may input the number of selected items together with a selection instruction. In such a case, the checkout process unit 112 in step 2206 can obtain the amount of money by multiplying the price of the item, the weight of the item and the number of the items by each other.

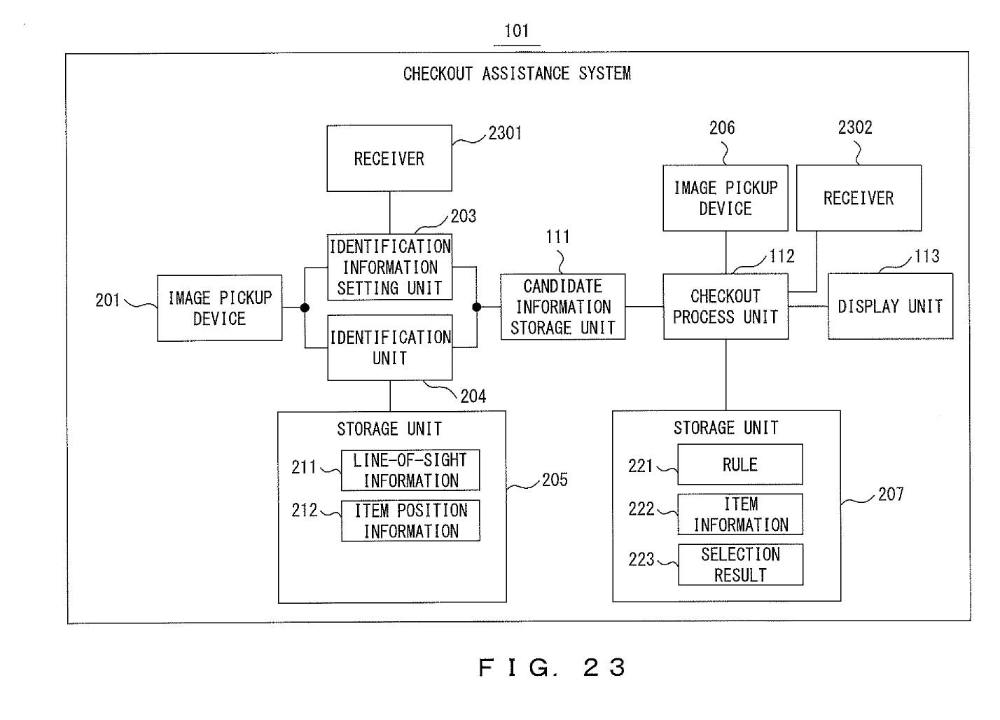

FIG. 23 illustrates a second specific example of the checkout assistance system 101 illustrated in FIG. 1. The checkout assistance system 101 illustrated in FIG. 23 has a configuration in which the feature amount information storage unit 202 is deleted from the checkout assistance system 101 illustrated in FIG. 2 and a receiver 2301 and a receiver 2302 are added to the same checkout assistance system.

The receiver 2301 receives identification information transmitted from a carrying tool, and the identification information setting unit 203 sets the received identification information in candidate information stored in the candidate information storage unit 111. The receiver 2302 receives identification information transmitted from a carrying tool, and the checkout process unit 112 extracts candidate information that includes the received identification information.

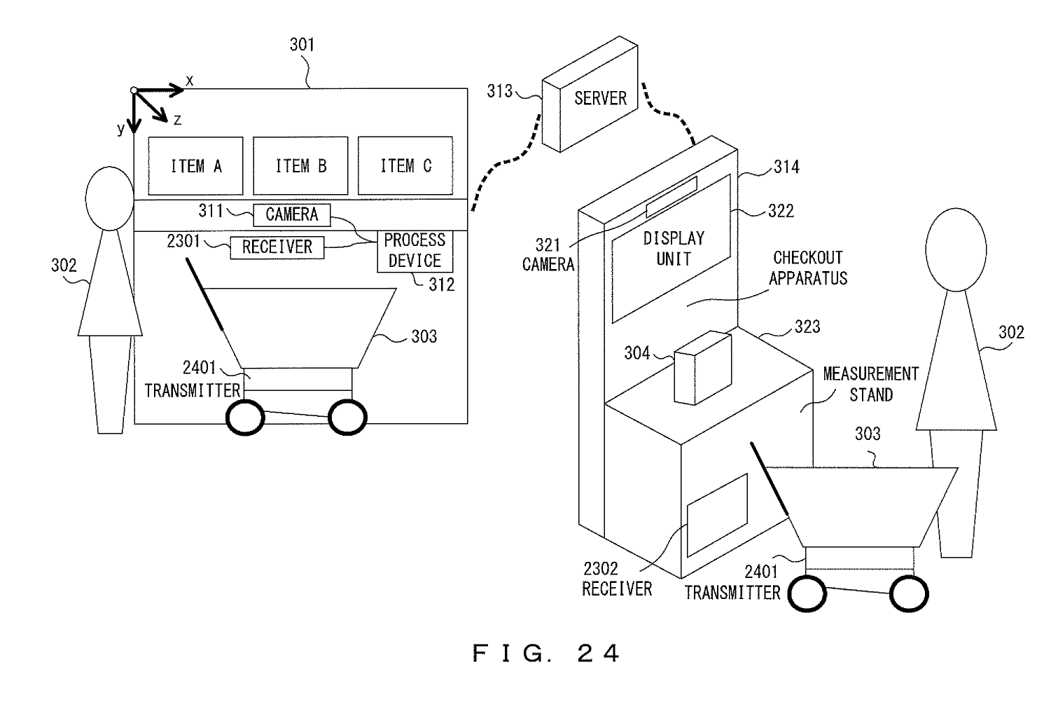

FIG. 24 illustrates a first configuration example of a self-checkout system to which the checkout assistance system 101 in FIG. 23 is applied. The self-checkout system illustrated in FIG. 24 has a configuration in which the receiver 2301, the receiver 2302 and a transmitter 2401 are added to the self-checkout system illustrated in FIG. 3.

The receiver 2301 and the receiver 2302 are provided to the shelf 301 and the checkout apparatus 314, respectively, and the transmitter 2401 is attached to the cart 303. The transmitter 2401 transmits the identification information of the cart 303 to the receiver 2301 and the receiver 2302 via wireless communications.

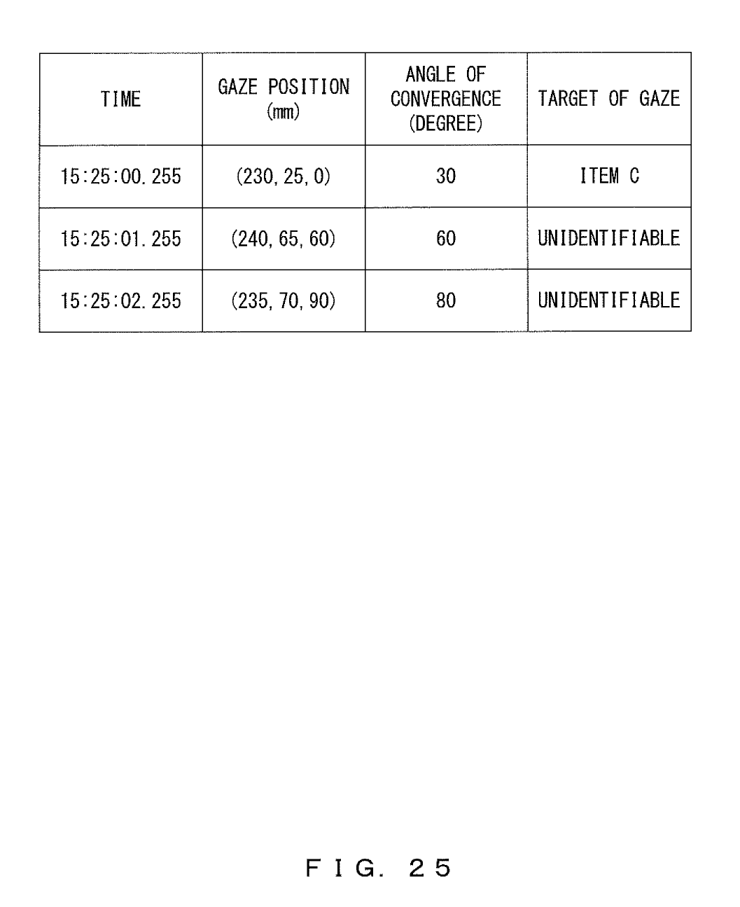

FIG. 25 illustrates an example of the line-of-sight information 211 used in the self-checkout system illustrated in FIG. 24. Each record of the line-of-sight information 211 includes time, a gaze position, an angle of convergence and a target of gaze. Among these pieces of information, time, a gaze position and a target of gaze are similar to those in the line-of-sight information 211 in FIG. 6. An angle of convergence represents the angle between both eyes of the customer 302, and is calculated on the basis of the line of sight detected from an image of the customer 302 picked up by the camera 311. The closer the gaze position that the customer 302 gazes at is to the customer 302, the greater the angle of convergence becomes, and the more distant the gaze position is from the customer 302, the smaller the angle of convergence becomes.

For example, the angle of convergence corresponding to the gaze position at 15:25:00.255 is 30 degrees, and the target of gaze is item C. Note that the gaze positions at 15:25:01.255 and at 15:25:02.255 are positions that are closer to the customer 302 than is the shelf 301, and thus there does not exist a corresponding item and it is not possible to identify the target of gaze.

Examples of the item position information 212, candidate information, the rule 221, the item information 222 and the selection result 223 used in the self-checkout system in FIG. 24 are similar to those in FIG. 7 and FIG. 9 through FIG. 12. The candidate generation process and the customer detection process in the self-checkout system in FIG. 24 are similar to those in FIG. 14 and FIG. 15, respectively.

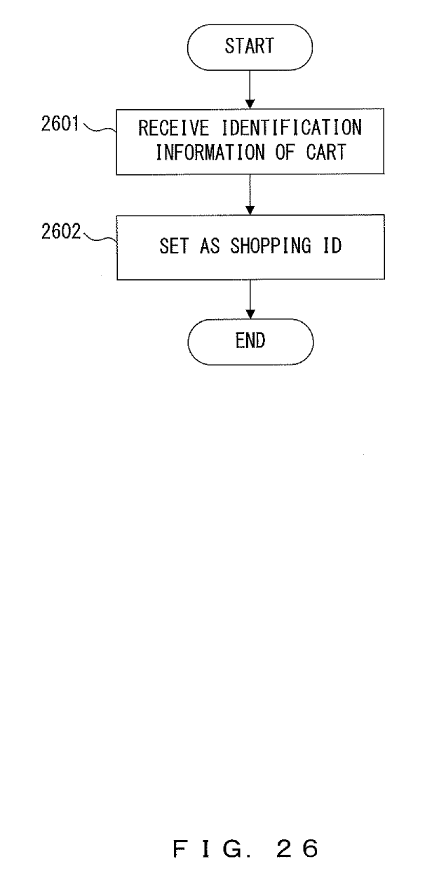

FIG. 26 is a flowchart illustrating an example of a shopping ID setting process in the self-checkout system in FIG. 24. First, the receiver 2301 receives the identification information of the cart 303 from the transmitter 2401 of the cart 303 (step 2601). Next, the identification information setting unit 203 generates a new record of candidate information to store the record in the candidate information storage unit 111, and sets the received identification information of the cart 303 as the shopping ID of the generated record of candidate information (step 2602).

A shopping ID setting process such as this makes it possible for the identification information setting unit 203 to seta shopping ID in a record of candidate information without extracting a feature vector of the face of the customer 302.

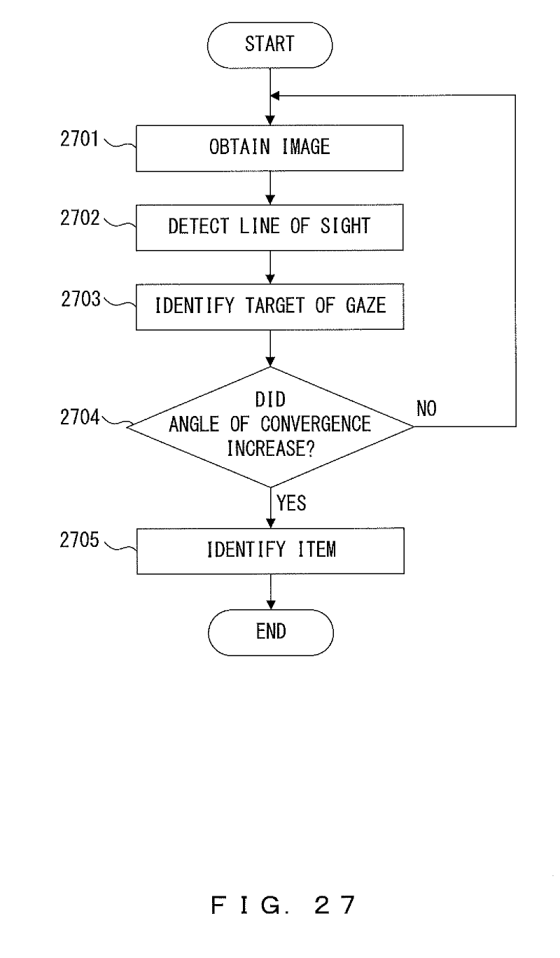

FIG. 27 is a flowchart illustrating an example of a checkout target identification process in the self-checkout system in FIG. 24. First, the identification unit 204 obtains an image picked up by the camera 311 (step 2701). Then, the identification unit 204 detects the line of sight of the customer 302 from the obtained image, detects the gaze position specified by the line of sight from the detected line of sight, and obtains the angle of convergence (step 2702). In this process, the identification unit 204 calculates the angle between the line-of-sight vectors of the right and left eyes of the customer 302 as the angle of convergence.

Next, the identification unit 204 compares the gaze position specified by the line of sight and the item position information 212, and identifies the target of gaze corresponding to the gaze position (step 2703). Then, the identification unit 204 generates a record of the line-of-sight information 211 that associates the current time, the gaze position, the angle of convergence and the identified target of gaze with each other, and stores the record in the storage unit 205.

Next, the identification unit 204 checks whether or not the angle of convergence increased by a prescribed angle or more in a past prescribed period of time (step 2704). It is determined that the angle of convergence increased by a prescribed angle or more when for example α1 is greater than α2 by a prescribed angle or more where α1 is the angle of convergence specified by the record at the current time in the line-of-sight information 211 and α2 is the angle of convergence specified by a record at certain time in a past prescribed period of time.

The past prescribed period of time may be an average period of time that elapses between when the customer 302 gazes at an item on the shelf 301 and when he or she picks up the item with hand or may be a period of time that ranges approximately between one second and several seconds. The prescribed angle may be determined on the basis of an average distance between the position of an item on the shelf 301 and the position of that item when it was picked up with hand by the customer 302 or may be about several tens of degrees.

When the angle of convergence did not increase by a prescribed angle or more in the past prescribed period of time (NO in step 2704), the identification unit 204 repeats the processes in and subsequent to step 2701. When the angle of convergence increased by a prescribed angle or more in the past prescribed period of time (YES in step 2704), the identification unit 204 identifies, as an item selected by the customer 302 as a purchase target, the item of the target of gaze specified by a record prior to the increase in the angle of convergence (step 2705). Then, the identification unit 204 associates the current time and the item name of the identified item with the shopping ID set by the identification information setting unit 203, and sets the pieces of information in the record of candidate information generated by the identification information setting unit 203.

At 15:25:00.255 in the line-of-sight information 211 in FIG. 25, the target of gaze is item C and the angle of convergence is 30 degrees. Also, the angle of convergence at 15:25:02.255 is 80 degrees. When for example the past prescribed period of time is three seconds and the prescribed angle is 30 degrees, the angle of convergence increased by a prescribed angle or more within the prescribed period of time. Accordingly, item C is identified, and 15:25:02.255 and item C are set in a record of candidate information in association with the shopping ID “1085” as illustrated in FIG. 9.

It is considered that the customer 302 often picks up an item with hand and gazes at it before putting it into the cart 303. According to the checkout target identification process illustrated in FIG. 27, when the customer 302 picks up an item with hand to gaze at it within a prescribed period of time after gazing at that item on the shelf 301, that item is included as a checkout target. This makes it possible to generate candidate information including an item that the customer 302 highly likely put into the cart 303.

The candidate presentation process, the customer detection process, the checkout target item determination process and the checkout process in the self-checkout system in FIG. 24 are similar to those in FIG. 19, FIG. 15, FIG. 21 and FIG. 22, respectively.

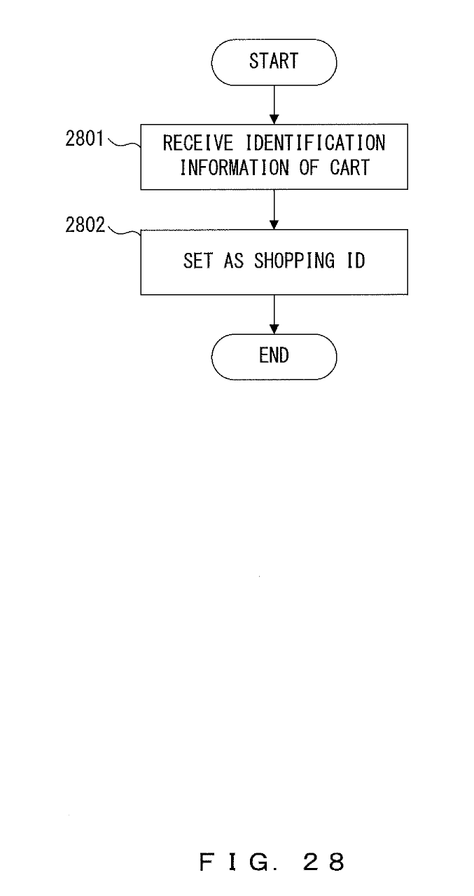

FIG. 28 is a flowchart illustrating an example of a shopping ID identification process in the candidate presentation process. First, the receiver 2302 receives the identification information of the cart 303 from the transmitter 2401 of the cart 303 (step 2801). Next, the checkout process unit 112 obtains, as a shopping ID, the received identification information of the cart 303 (step 2802). A shopping ID identification process such as this makes it possible for the checkout process unit 112 to obtain a shopping ID without extracting a feature vector of the face of the customer 302.

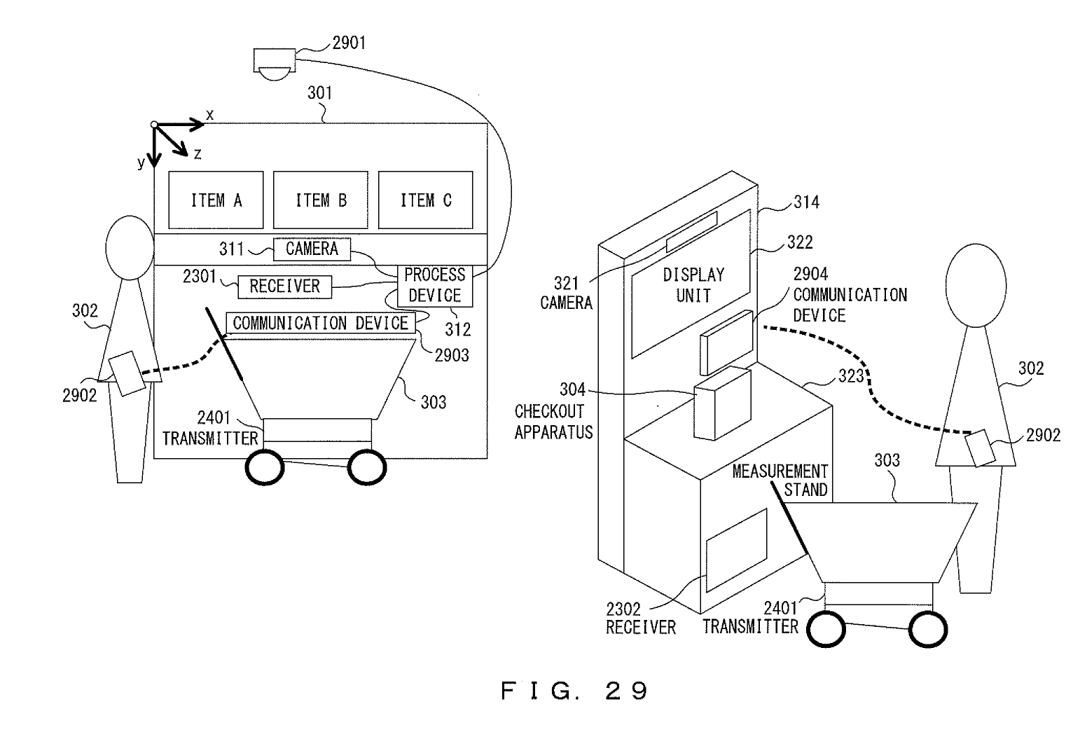

FIG. 29 illustrates a second configuration example of a self-checkout system to which the checkout assistance system 101 in FIG. 23 is applied. The self-checkout system in FIG. 29 has a configuration in which the server 313 is deleted from the self-checkout system illustrated in FIG. 24, and a camera 2901, a mobile terminal 2902, a communication device 2903 and a communication device 2904 are added to the same self-checkout system.

The camera 2901 is installed at the position on the ceiling that is directly above the camera 311, and can pick up an in-store video of the store. The in-store video includes images of a hand of the customer 302 who is reaching for an item on the shelf 301. The mobile terminal 2902 is an information processing apparatus, such as a smartphone, a tablet, a notebook personal computer, a wearable terminal, etc., that the customer 302 carries. The communication device 2903 and the communication device 2904 are installed in the shelf 301 and the checkout apparatus 314, respectively. The mobile terminal 2902 communicates with the communication device 2903 and the communication device 2904 via wireless communications.

The identification information setting unit 203, the identification unit 204 and the storage unit 205 in FIG. 23 are provided in the process device 312, the mobile terminal 2902 or the checkout apparatus 314. In such a case, these constituents may be provided in the process device 312, the checkout apparatus 314 and the mobile terminal 2902 in a distributed manner or may be concentrated in one of these devices. The candidate information storage unit 111 is provided in the process device 312, the mobile terminal 2902 or the checkout apparatus 314. As described above, performing information processes by using the mobile terminal 2902 of the customer 302 eliminates the necessity for the server 313 of FIG. 24.

When the candidate information storage unit 111, the identification information setting unit 203 and the identification unit 204 are provided in the process device 312, the identification unit 204 transmits candidate information in the candidate information storage unit 111 to the mobile terminal 2902 via the communication device 2903. And, when the customer 302 has come in front of the checkout apparatus 314, the checkout process unit 112 receives candidate information from the mobile terminal 2902 via the communication device 2904.

When the candidate information storage unit 111 is provided in the mobile terminal 2902 and the identification information setting unit 203 and the identification unit 204 are provided in the process device 312, the identification information setting unit 203 and the identification unit 204 access the candidate information storage unit 111 via the communication device 2903. The identification unit 204 then transmits the candidate information to the mobile terminal 2902 via the communication device 2903. The mobile terminal 2902 stores the received candidate information in the candidate information storage unit 111, and the checkout process unit 112 receives the candidate information from the mobile terminal 2902 via the communication device 2904 when the customer 302 comes in front of the checkout apparatus 314.

When the candidate information storage unit 111 is provided in the checkout apparatus 314 and the identification information setting unit 203 and the identification unit 204 are provided in the process device 312, the identification unit 204 transmits candidate information to the mobile terminal 2902 via the communication device 2903. When the customer 302 comes in front of the checkout apparatus 314, the checkout process unit 112 receives the candidate information from the mobile terminal 2902 via the communication device 2904, and stores the received candidate information in the candidate information storage unit 111.

In a case when the candidate information storage unit 111 is provided in the checkout apparatus 314 and the identification information setting unit 203 and the identification unit 204 are provided in the mobile terminal 2902, the identification unit 204 transmits candidate information to the checkout apparatus 314 when the customer 302 has come in front of the checkout apparatus 314. The checkout process unit 112 then receives the candidate information from the mobile terminal 2902 via the communication device 2904, and stores the received candidate information in the candidate information storage unit 111.

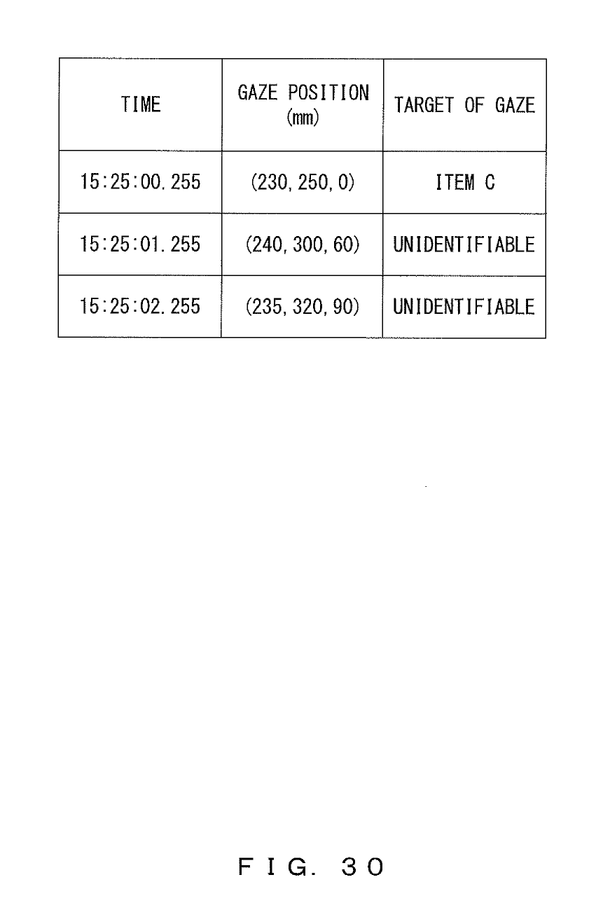

FIG. 30 illustrates an example of the line-of-sight information 211 used in the self-checkout system in FIG. 29. Each record of the line-of-sight information 211 includes time, a gaze position and a target of gaze similarly to that of the line-of-sight information 211 illustrated in FIG. 6. The gaze positions at 15:25:01.255 and at 15:25:02.255 are positions that are closer to the customer 302 than is the shelf 301, and thus there does not exist a corresponding item and it is not possible to identify the target of gaze.

Examples of the item position information 212, candidate information, the rule 221, the item information 222 and the selection result 223 used in the self-checkout system in FIG. 29 are similar to those in FIG. 7 and FIG. 9 through FIG. 12. The candidate generation process, the customer detection process and the shopping ID setting process in the self-checkout system in FIG. 29 are similar to those in FIG. 14, FIG. 15 and FIG. 26, respectively.

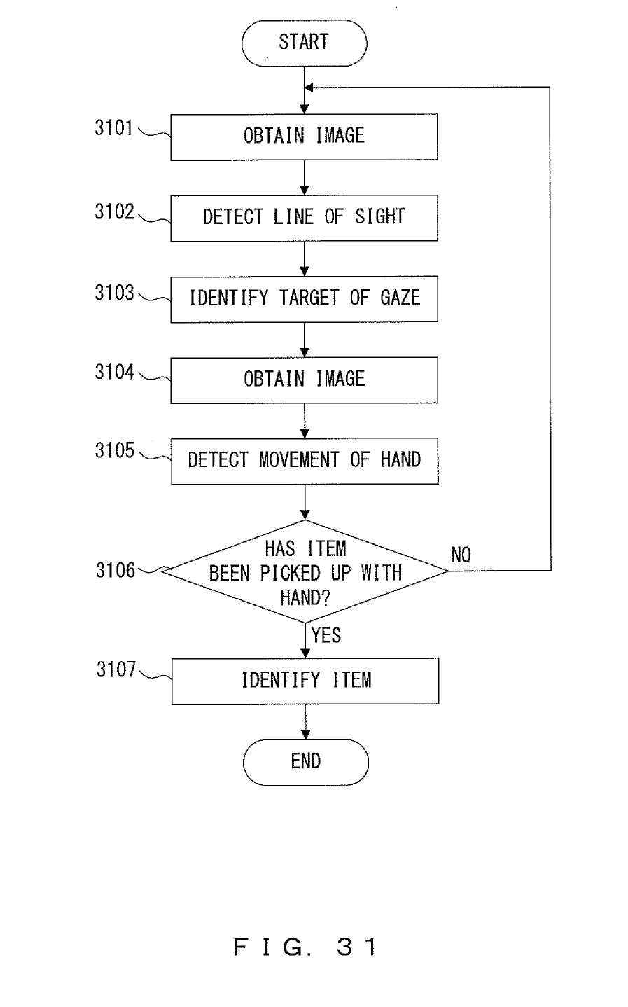

FIG. 31 is a flowchart illustrating an example of a checkout target identification process in the self-checkout system in FIG. 29. First, the identification unit 204 obtains an image picked up by the camera 311 (step 3101). Then, the identification unit 204 detects the line of sight of the customer 302 from the obtained image, and detects the gaze position specified by the line of sight on the basis of the detected line of sight (step 3102).

Next, the identification unit 204 compares the gaze position specified by the line of sight and the item position information 212, and identifies the target of gaze that corresponds to the gaze position (step 3103). Then, the identification unit 204 generates a record of the line-of-sight information 211 that associates the current time, the gaze position and the identified target of gaze with each other, and stores the record in the storage unit 205.

Next, the identification unit 204 obtains images picked up by the camera 2901 (step 3104). Then, the identification unit 204 detects a movement of a hand of the customer 302 from the obtained images (step 3105), and checks whether or not the customer 302 has picked up an item with hand (step 3106). The identification unit 204 uses for example the method disclosed by Patent Document 3 to analyze the images obtained by the camera 2901, and thereby can determine whether or not the customer 302 has picked up an item with hand.

When the customer 302 has not picked up an item with hand (NO in step 3106), the identification unit 204 repeats the processes in and subsequent to step 3101. When the customer 302 has picked up an item with hand (YES in step 3106), the identification unit 204 identifies an item as an item selected by the customer 302 as a purchase target, the identified item being the item as the target of gaze identified in step 3103 (step S3107). Then, the identification unit 204 associates the current time and the item name of the identified item with the shopping ID set by the identification information setting unit 203, and sets these pieces of information in the record of candidate information generated by the identification information setting unit 203.

According to the checkout target identification process illustrated in FIG. 31, when the customer 302 picks up an item with hand after gazing at that item on the shelf 301, that item is included in the candidate information as a checkout target. This makes it possible to generate candidate information including an item that the customer 302 highly likely put into the cart 303.

The candidate presentation process, the customer detection process, the shopping ID identification process, the checkout target item determination process and the checkout process in the self-checkout system in FIG. 29 are similar to those in FIG. 19, FIG. 15, FIG. 28, FIG. 21 and FIG. 22, respectively.

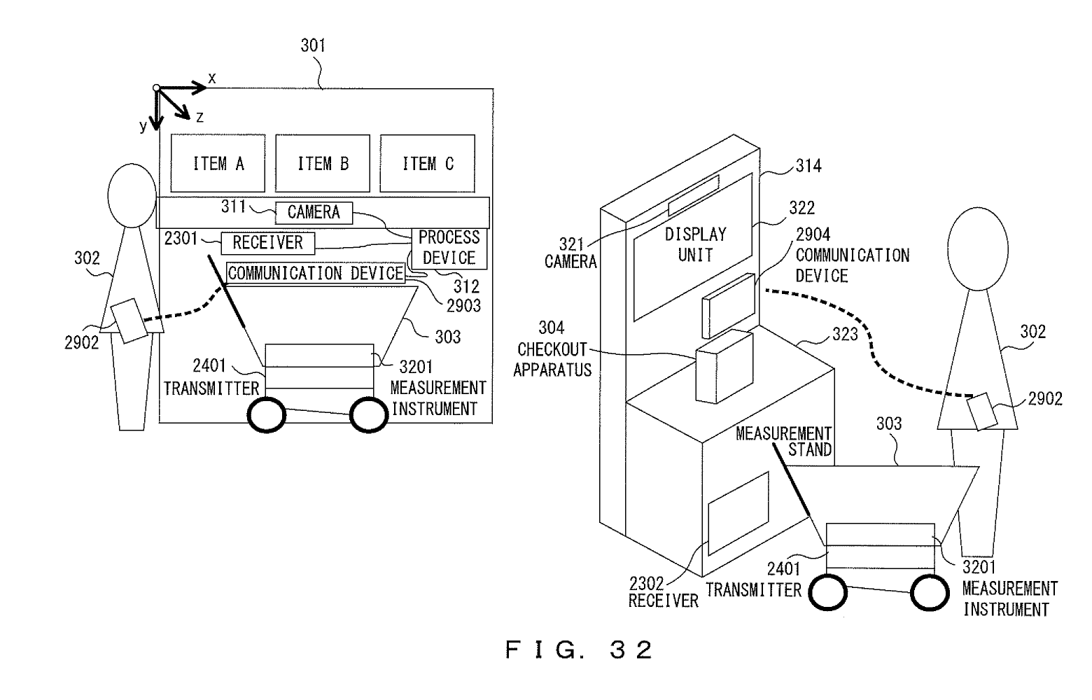

FIG. 32 illustrates a third configuration example of a self-checkout system to which the checkout assistance system 101 in FIG. 23 is applied. The self-checkout system in FIG. 32 has a configuration in which the camera 2901 is deleted from the self-checkout system in FIG. 29 and a measurement instrument 3201 is added to the same self-checkout system.

The measurement instrument 3201 is attached to the cart 303, and can measure the total weight of the items in the cart 303. The transmitter 2401 transmits the total weight measured by the measurement instrument 3201 to the receiver 2301 via wireless communications. Instead of the total weight, the measurement instrument 3201 may measure a change in the total weight that occurs when the customer 302 puts an item in the cart 303.

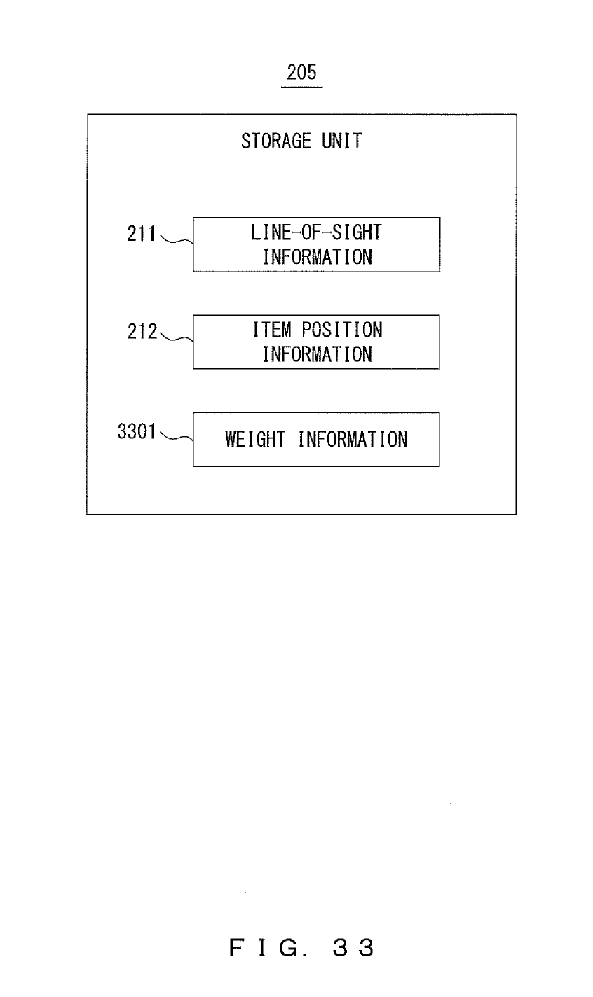

FIG. 33 illustrates an example of information that is stored in the storage unit 205 in the self-checkout system in FIG. 32. In this example, the storage unit 205 stores the line-of-sight information 211, the item position information 212 and weight information 3301. The weight information 3301 is information representing the total amount of the items in the cart 303.

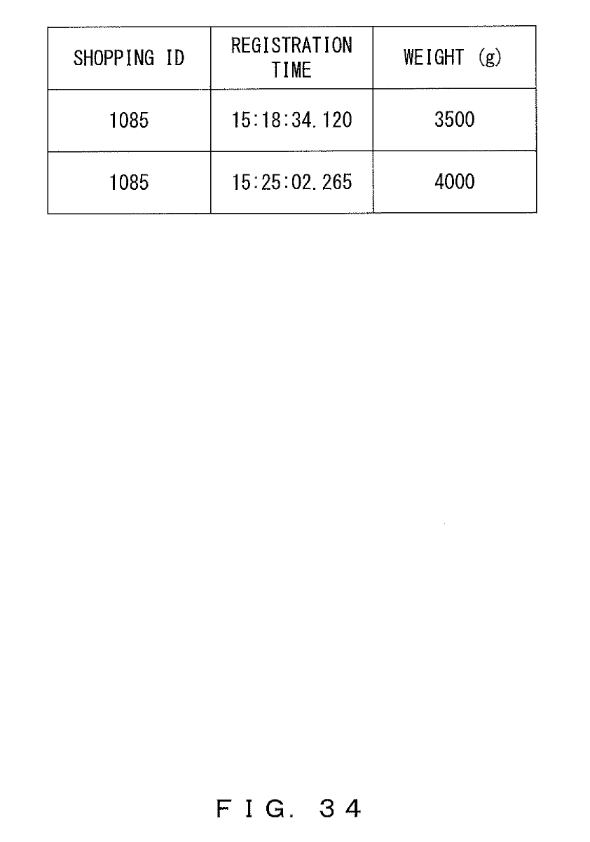

FIG. 34 illustrates an example of the weight information 3301. Each record of the weight information 3301 includes a shopping ID, registration time and a weight. A shopping ID corresponds to the identification information of the cart 303 that is transmitted from the transmitter 2401, registration time represents the time at which the record was registered, and a weight represents the total weight transmitted from the transmitter 2401.

In this example, the weights at 15:18:34.120 and at 15:25:02.265 are 3500 g and 4000 g, respectively, which indicates that the total weight increased by 500 g.

Examples of the line-of-sight information 211, the item position information 212, candidate information, the rule 221, the item information 222 and the selection result 223 used in the self-checkout system in FIG. 32 are similar to those in FIG. 30, FIG. 7 and FIG. 9 through FIG. 12, respectively. The candidate generation process, the customer detection process and the shopping ID setting process in the self-checkout system in FIG. 32 are similar to those in FIG. 14, FIG. 15 and FIG. 26, respectively.

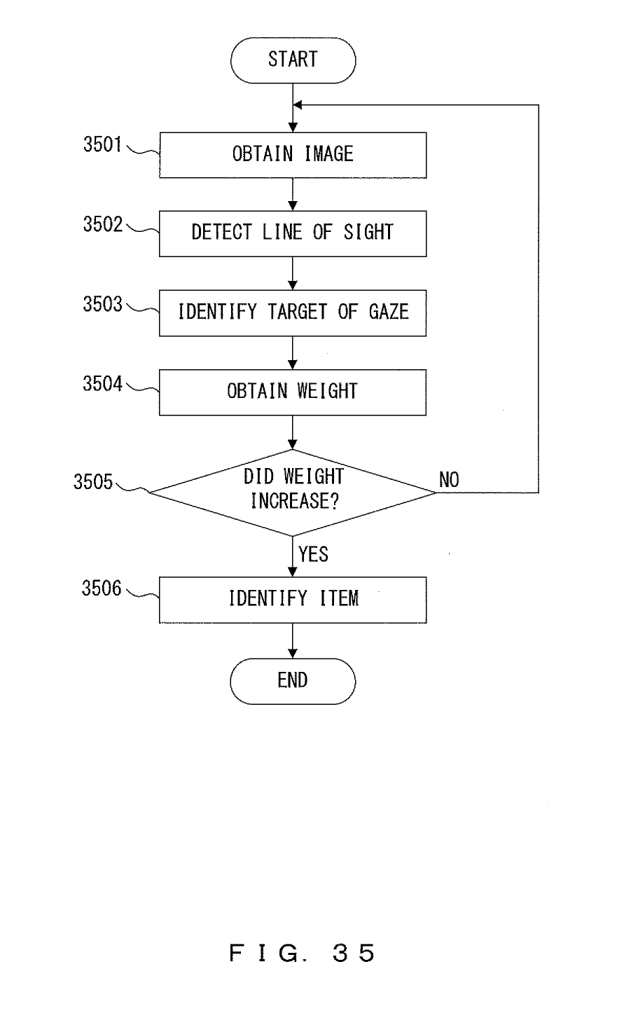

FIG. 35 is a flowchart illustrating an example of a checkout target identification process in the self-checkout system in FIG. 32. The processes in step 3501 through step 3503 are similar to those in step 3101 through step 3103 in FIG. 31.

After identifying the target of gaze, the identification unit 204 obtains the total weight that the receiver 2301 received from the transmitter 2401 (step 3504). The identification unit 204 then generates a record of the weight information 3301 that associates a shopping ID, the current time and the obtained total amount, and stores the record in the storage unit 205, the shopping ID having been set in a record of candidate information by the identification information setting unit 203.

Next, on the basis of the weight information 3301, the identification unit 204 checks whether or not the weight indicated by the weight information 3301 increased in a past prescribed period of time (step 3505). It is determined that the weight increased when for example W1 is greater than W2 where W1 is the weight specified by the record at the current time in the weight information 3301 and W2 is the weight specified by a record at certain time in a past prescribed period of time. The past prescribed period of time may be an average period of time that elapses between when the customer 302 gazes at an item on the shelf 301 and when he or she puts that item into the cart 303 or may be a period of time that ranges approximately between one second and several seconds.

When the weight indicated by the weight information 3301 did not increase in the past prescribed period of time (NO in step 3505), the identification unit 204 repeats the processes in and subsequent to step 3501. When the weight indicated by the weight information 3301 increased in the past prescribed period of time (YES in step 3505), the identification unit 204 identifies an item as an item selected as a purchase target by the customer 302, the identified item being the item as the target of gaze identified in step 3503 (step 3506). The identification unit 204 then associates the current time and the item name of the identified item with the shopping ID set by the identification information setting unit 203, and sets these pieces of information in the record of the candidate information generated by the identification information setting unit 203.

According to the checkout target identification process illustrated in FIG. 35, because the total weight of the items in the cart 303 increases when the customer 302 puts an item into the cart 303 after gazing at that item on the shelf 301, that item is included in the candidate information as a checkout target. This makes it possible to generate candidate information including an item that the customer 302 highly likely put into the cart 303.

The candidate presentation process, the customer detection process, the shopping ID identification process and the checkout target item determination process in the self-checkout system in FIG. 32 are similar to those in FIG. 19, FIG. 15, FIG. 28 and FIG. 21, respectively.

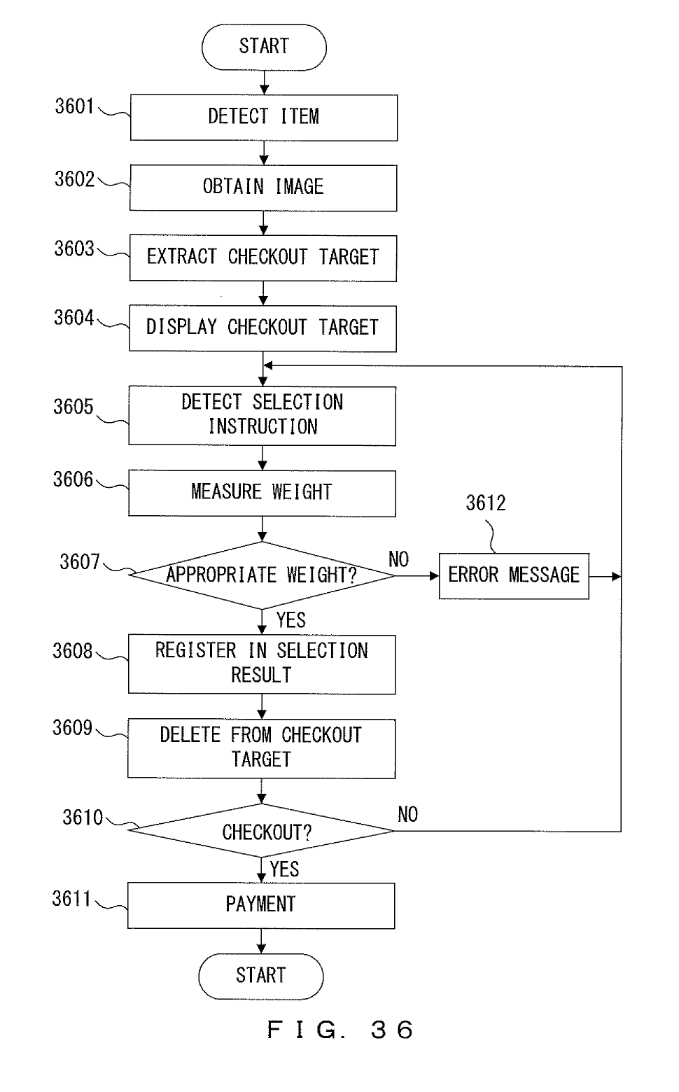

FIG. 36 is a flowchart illustrating an example of a checkout process in the candidate presentation process. First, the checkout process unit 112 detects that an item was put on the measurement stand 323 by the customer 302 (step 3601) similarly to step 2203 in FIG. 22.

Next, the checkout process unit 112 obtains an image picked up by the camera 321 (step 3602). From among representative records of candidate information stored in the candidate information storage unit 111, the checkout process unit 112 then extracts, as a checkout target, the item name of at least one item that is highly likely included in the obtained image (step 3603).

The checkout process unit 112 uses for example the method disclosed by Patent Document 2 to search an item file storing data related to exterior features of items for an item that is close to an exterior feature of the item included in the image, and thereby can identify at least one item. The checkout process unit 112 may identify an item on the basis of a combination of an exterior feature and the weight, etc. of an item.

Next, the checkout process unit 112 displays the item name of at least one extracted item on the screen of the display unit 322 (step 3604). Thereby, the item name of an item that the customer 302 highly likely put on the measurement stand 323 is displayed as an option for a checkout target. The checkout process unit 112 then detects a selection instruction input by the customer 302 (step 3605). The processes in step 3606 through step 3612 are similar to those in step 2204 through step 2210 in FIG. 22.

In the self-checkout system illustrated in FIG. 32, when the customer 302 returns, to the shelf 301, an item that he or she once put into the cart 303, the total weight of the items in the cart 303 decreases by the weight of that item. Accordingly, the return of an item can be detected on the basis of a change in the total weight measured by the measurement instrument 3201.

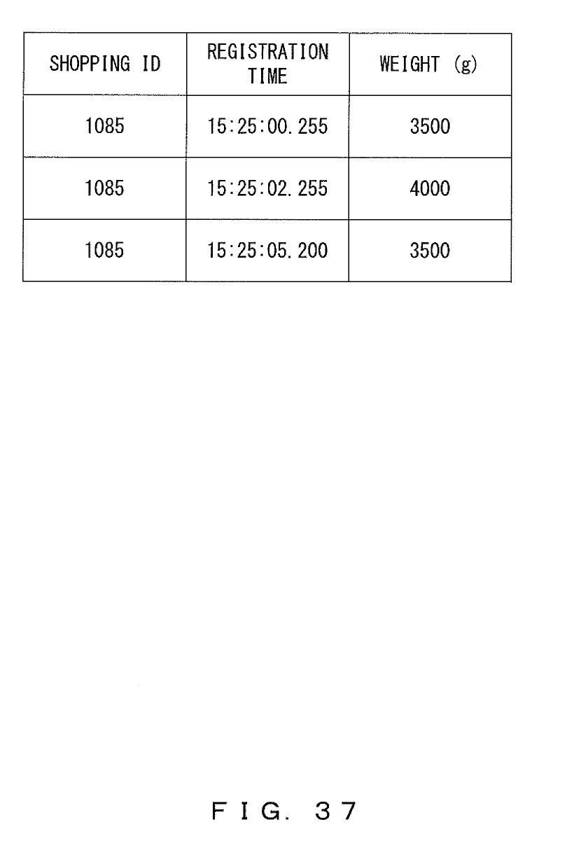

FIG. 37 illustrates an example of the weight information 3301 in a case when an item is returned. In this example, the weight was 3500 g at 15:25:00.255, increased to 4000 g at 15:25:02.255, and decreased to 3500 g at 15:25:05.200. This indicates that an item of 500 g was once put into the cart 303 and thereafter that item was returned from the cart 303 to the shelf 301.

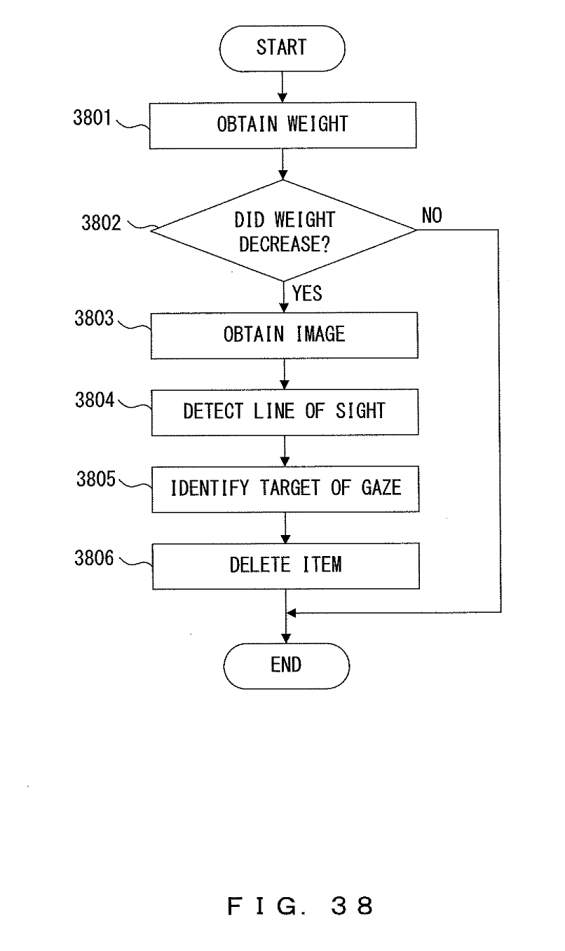

FIG. 38 is a flowchart illustrating an example of a returned item detection process in which the return of an item is detected. First, the identification unit 204 obtains the total amount that the receiver 2301 received from the transmitter 2401 (step 3801). Then, the identification unit 204 checks whether or not the weight indicated by the weight information 3301 decreased in a past prescribed period of time on the basis of the weight information 3301 (step 3802).

It is determined that the weight decreased when for example W3 is smaller than W1 where W3 is the weight specified by the record at the current time in the weight information 3301 and W1 is the weight specified by a record at certain time in a past prescribed period of time. The past prescribed period of time may be an average period of time that elapses between when the customer 302 puts an item from the shelf 301 into the cart 303 and when he or she returns the item to the shelf 301 or may be a period of time that ranges approximately between one second and several minutes.

When the weight indicated by the weight information 3301 decreased in the past prescribed period of time (YES in step 3802), the identification unit 204 performs the processes in step 3803 through step 3805, and identifies the item as the target of gaze specified by the line of sight of the customer 302. The processes in step 3803 through step 3805 are similar to those in step 3101 through step 3103 in FIG. 31. Then, the identification unit 204 determines that the identified item was returned and deletes the record corresponding to that item from the candidate information (step 3806).

When the weight indicated by the weight information 3301 did not decrease in the past prescribed period of time (NO in step 3802), the identification unit 204 terminates the process.

The returned item detection process illustrated in FIG. 38 makes it possible to exclude an item from the candidate information when the customer 302 once puts that item into the cart 303 and returns it to the shelf 301. The timing of the return may be immediately after the customer 302 puts the item into the cart 303 or may be when a certain period of time has elapsed after that.

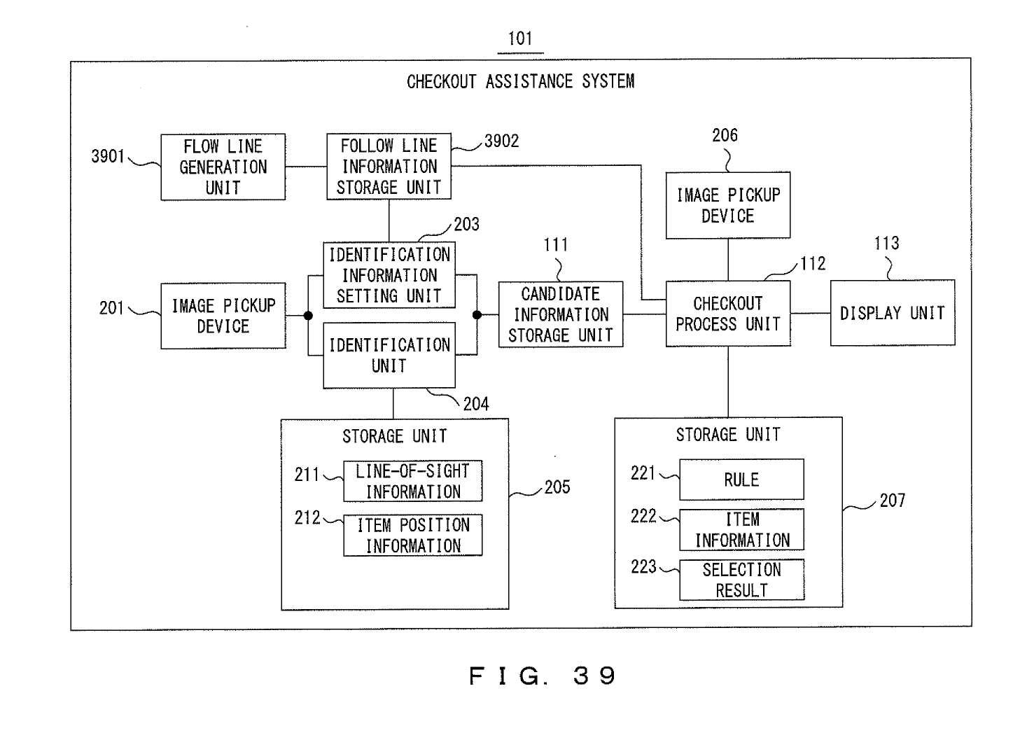

FIG. 39 illustrates a third specific example of the checkout assistance system 101 illustrated in FIG. 1. The checkout assistance system 101 illustrated in FIG. 39 has a configuration in which the feature amount information storage unit 202 is deleted from the checkout assistance system 101 of FIG. 2 and a flow line generation unit 3901 and a flow line information storage unit 3902 are added to the same the checkout assistance system 101.

The flow line information storage unit 3902 stores flow line information, which associates identification information of a plurality of mobile objects that move in the store with flow lines of such mobile objects with each other. The flow line generation unit 3901 detects a mobile object from an in-store video of the store, generates flow line information, and stores the generated flow line information in the flow line information storage unit 3902. The identification information setting unit 203 sets identification information associated by the flow line information with a flow line existing within a prescribed distance from the image pickup device 201, as the identification information for the checkout for a customer in candidate information stored in the candidate information storage unit 111.

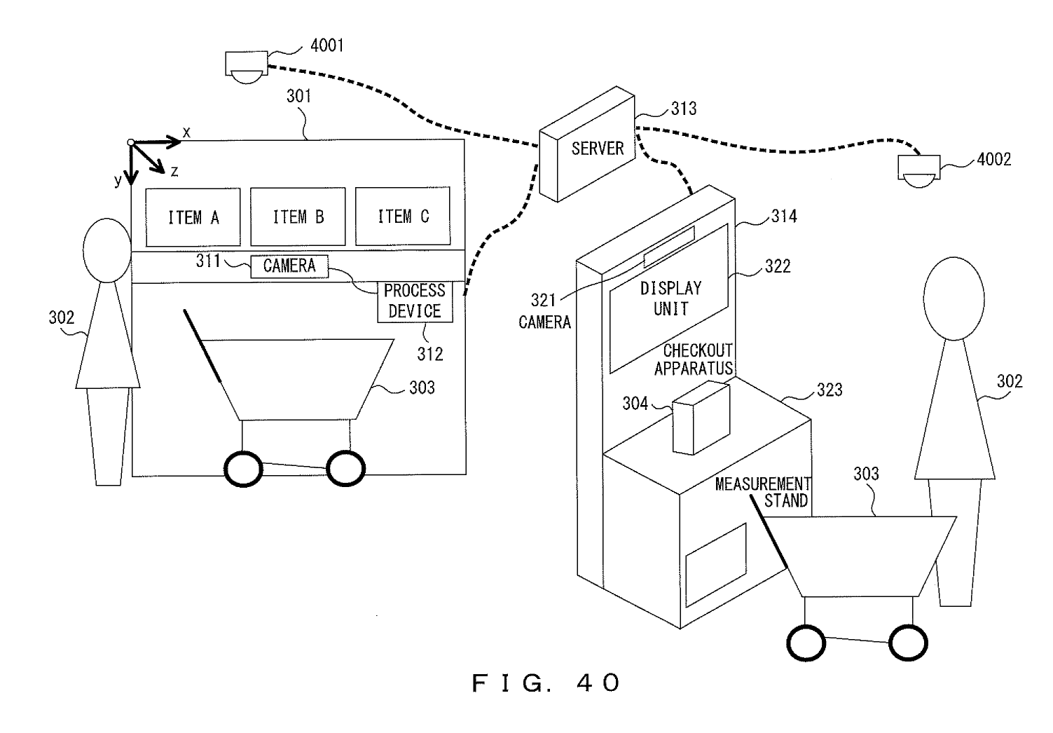

FIG. 40 illustrates a configuration example of a self-checkout system to which the checkout assistance system 101 illustrated in FIG. 39 is applied. The self-checkout system illustrated in FIG. 40 has a configuration in which a monitor camera 4001 and a monitor camera 4002 are added to the self-checkout system illustrated in FIG. 3.

The monitor camera 4001 is installed at a position on the ceiling around the shelf 301, and picks up a video of the area around the shelf 301 to transmit the video to the server 313. The monitor camera 4002 is installed at a position on the ceiling around the checkout apparatus 314, and picks up a video of the area around the checkout apparatus 314 to transmit the video to the server 313.

The flow line generation unit 3901 and the flow line information storage unit 3902 illustrated in FIG. 39 are provided in the server 313. From videos obtained from a plurality of monitor cameras including the monitor camera 4001 and the monitor camera 4002, the flow line generation unit 3901 detects as a mobile object the customer 302 who moves in the store, and generates flow line information, which represents a flow line of the customer 302. The flow line generation unit 3901 may detect the cart 303 instead of the customer 302 as a mobile object.

When the identification information setting unit 203 is provided in the process device 312, the identification information setting unit 203 accesses the flow line information storage unit 3902 via a communication network. The checkout process unit 112 accesses the flow line information storage unit 3902 via a communication network.

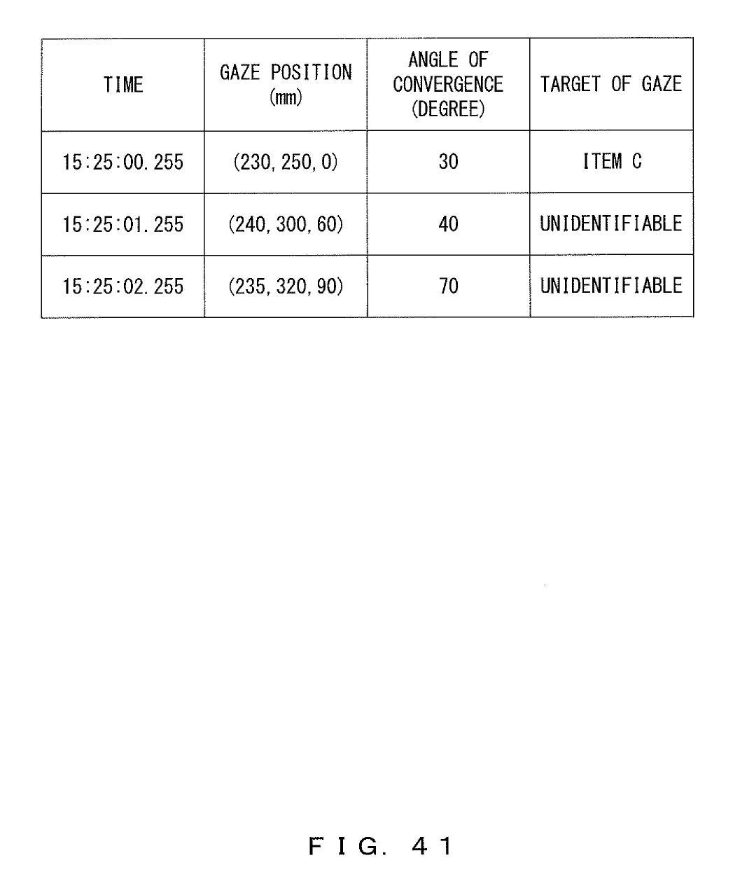

FIG. 41 illustrates an example of the line-of-sight information 211 that is used in the self-checkout system illustrated in FIG. 40. Each record of the line-of-sight information 211 includes time, a gaze position, an angle of convergence and a target of gaze similarly to the line-of-sight information 211 in FIG. 25.

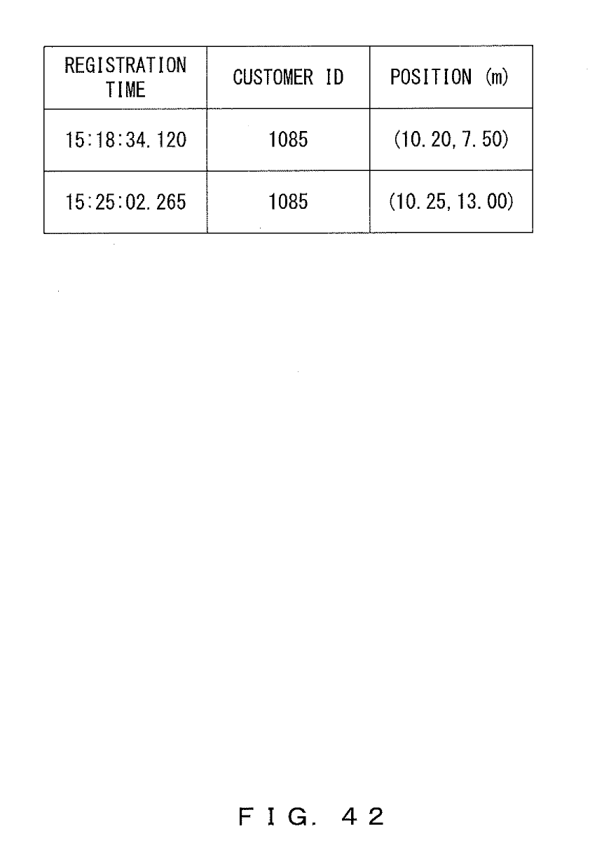

FIG. 42 illustrates an example of flow line information stored in the flow line information storage unit 3902. Each record of the flow line information includes registration time, a customer ID and a position. Registration time represents the time at which the record was registered and a customer ID represents the identification information of the customer 302 detected from a video. A position represents the position of the customer 302 on the two-dimensional plane of the store, and is expressed by using an XY coordinate system having its origin at the entrance of the store.

For example, the position registered at 15:18:34.120 in association with the customer ID “1085” is (X, Y)=(10.20, 7.50), which specifies the point that is apart from the origin by 10.20 m and 7.50 m in the directions of X axis and Y axis, respectively. Also, the position registered at 15:25:02.265 in association with the same customer ID “1085” is (X, Y)=(10.25, 13.00). By registering the positions of the customer 302 at a plurality of points in time between when the customer 302 appears at the entrance of the store and when he or she arrives at the checkout apparatus 314, the flow line of the customer 302 can be generated.

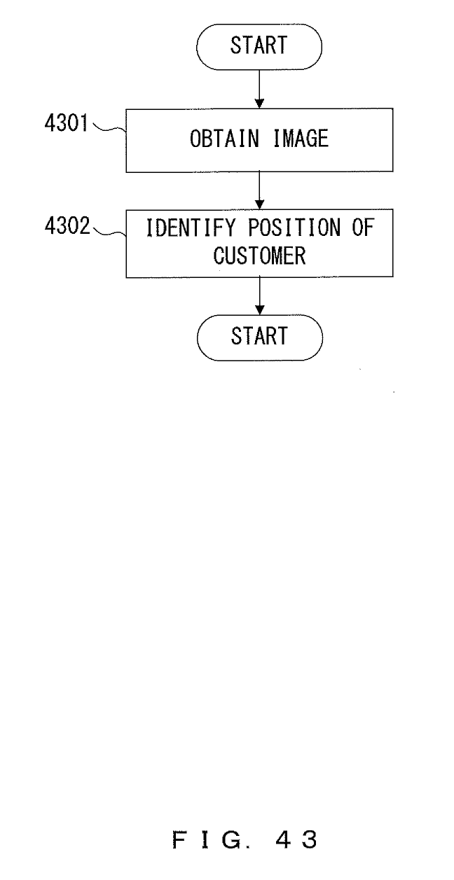

FIG. 43 is a flowchart illustrating an example of a flow line generation process that is performed in a regular cycle by the flow line generation unit 3901. First, the flow line generation unit 3901 obtains videos picked up by a plurality of monitor cameras including the monitor camera 4001 and the monitor camera 4002 (step 4301).

Next, the flow line generation unit 3901 traces the positions of the customer 302 on the basis of images at a plurality of points in time from a past certain point to the present, and thereby identifies the position of the customer 302 at the current time (step 4302). When the identified position corresponds to the entrance of the store, the flow line generation unit 3901 generates a record of flow line information that associates the current time, a new customer ID and the identified position with each other, and stores the record in the flow line information storage unit 3902.

When the identified position corresponds to a position that is not the entrance, the flow line generation unit 3901 searches records of flow line information that have already been registered, for a record including a position determined to belong to the same flow line as the flow line to which the identified position belongs, and thereby obtains the customer ID from that record. The flow line generation unit 3901 then generates a record of flow line information that associates the current time, the identified customer ID and the identified position with each other, and stores the record in the flow line information storage unit 3902. When for example the distance between the identified position and the position included in the record that was registered immediately previously is equal to or shorter than a threshold, the flow line generation unit 3901 may determine that these positions belong to the same flow line.

Examples of the item position information 212, the candidate information, the rule 221, the item information 222 and the selection result 223 used in the self-checkout system illustrated in FIG. 40 are similar to those in FIG. 7 and FIG. 9 through FIG. 12. The candidate generation process, the customer detection process and the checkout target identification process in the self-checkout system illustrated in FIG. 40 are similar to those in FIG. 14, FIG. 15 and FIG. 27, respectively.

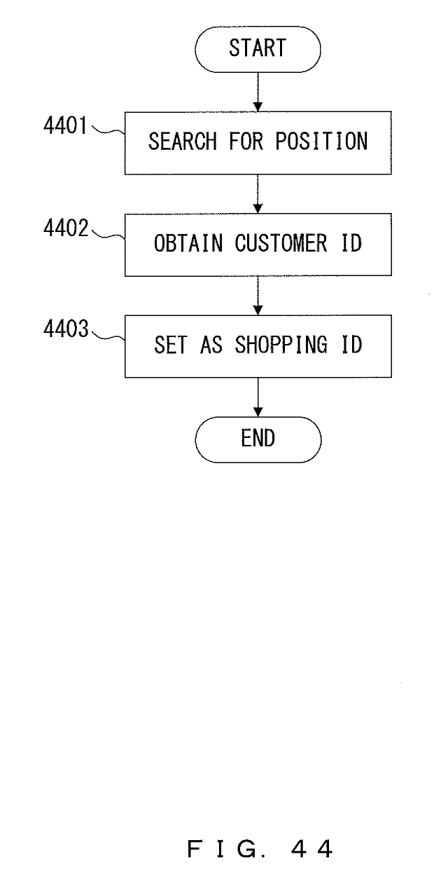

FIG. 44 is a flowchart illustrating an example of a shopping ID setting process in the self-checkout system illustrated in FIG. 40. First, the identification information setting unit 203 identifies the position of the camera 311 on the basis of the identification information of the shelf 301, and extracts a record including registration time in a past prescribed period of time from among records of the flow line information in the flow line information storage unit 3902 (step 4401). Then, the identification information setting unit 203 searches the extracted records for a record including a position within a prescribed distance from the camera 311.

The past prescribed period of time may be an average period of time that elapses between when the customer 302 comes in front of the camera 311 and when the identification information setting unit 203 detects the customer 302 or may be a period of time that ranges approximately between one second and several seconds. The prescribed distance may be an average distance between the camera 311 and the customer 302 or may be a distance ranging approximately between several tens of centimeters and one meter.

Next, the identification information setting unit 203 obtains the customer ID from the record of flow line information for which the search was conducted (step 4402). Then, the identification information setting unit 203 generates a new record of candidate information to store the record in the candidate information storage unit 111, and sets the obtained customer ID as the shopping ID of the generated record of candidate information (step 4403). A shopping ID setting process such as this makes it possible for the identification information setting unit 203 to set a shopping ID in a record of candidate information without extracting a feature vector of the face of the customer 302.

The candidate presentation process, the customer detection process, the checkout target item determination process and the checkout process in the self-checkout system illustrated in FIG. 40 are similar to those in FIG. 19, FIG. 15, FIG. 21 and FIG. 22, respectively.

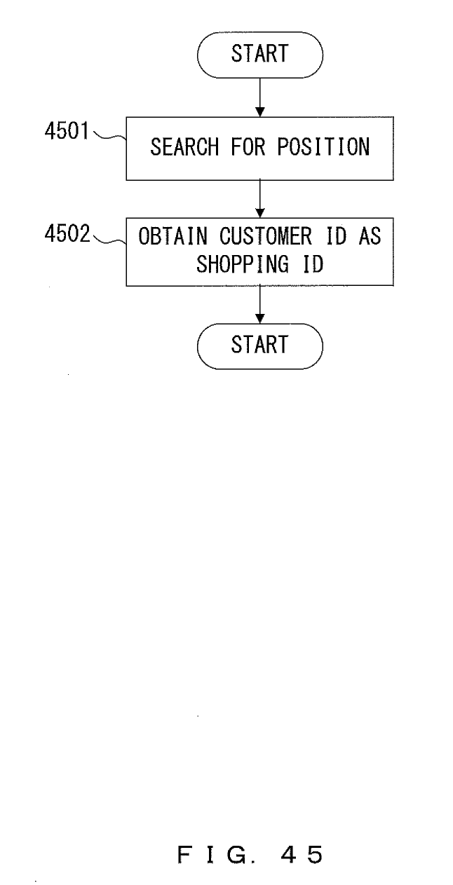

FIG. 45 is a flowchart illustrating an example of a shopping ID identification process in the self-checkout system illustrated in FIG. 40. First, the checkout process unit 112 identifies the position of the camera 321 on the basis of the identification information of the checkout apparatus 314, and extracts a record including registration time in a past prescribed period of time from among records of flow line information in the flow line information storage unit 3902 (step 4501). Also, the checkout process unit 112 searches for a record including a position within a prescribed distance from the camera 321 from among the extracted records.

The past prescribed period of time may be an average period of time that elapses between when the customer 302 comes in front of the camera 321 and when the checkout process unit 112 detects the customer 302 or may be a period of time that ranges approximately between one second and several seconds. The prescribed distance may be an average distance between the camera 321 and the customer 302 or may be a distance ranging approximately between several tens of centimeters and one meter.

Next, the checkout process unit 112 obtains, as a shopping ID, the customer ID included in the record of the flow line information for which the search was conducted (step 4502). A shopping ID identification process such as this makes it possible for the checkout process unit 112 to obtain a shopping ID without extracting a feature vector of the face of the customer 302.

In the shopping ID setting process illustrated in FIG. 44, the identification information setting unit 203 can also set a shopping ID that represents a customer group such as a family, a couple, etc. In such a case, the flow line generation unit 3901 uses for example the method disclosed by Patent Document 4 to group records of flow line information of a plurality of the customers 302 on the basis of the positions included in the pieces of flow line information of the customers 302 belonging to the customer group. Then, the flow line generation unit 3901 adds the shopping ID representing a customer group to each of the records that were grouped.

As a shopping ID representing a customer group, one of the customer IDs of a plurality of the customers 302 belonging to the customer group may be used or an ID different from such customer IDs may be used.

In step 4402 in FIG. 44, the identification information setting unit 203 obtains a shopping ID from the record of flow line information for which a search was conducted. Thereby, a shopping ID that represents a customer group is set in records of candidate information, and thus it is possible to use a single shopping ID to manage items that the plurality of the customers 302 belonging to the customer group put into the cart 303.

Also, in step 4502 in FIG. 45, the checkout process unit 112 obtains a shopping ID from a record of flow line information for which a search was conducted. Thereby, item names are extracted from records of candidate information having the shopping ID representing a customer group, and are displayed as options for checkout targets. This makes it possible to display, as checkout targets, items that a plurality of the customers 302 belonging to a customer group put into the cart 303.

The configurations of the checkout assistance system 101 illustrated in FIG. 1, FIG. 2, FIG. 23 and FIG. 39 are just examples, and some of the constituents can be omitted or changed in accordance with the purposes or conditions of the checkout assistance system 101. For example, in the checkout assistance system 101 illustrated in FIG. 2, FIG. 23 and FIG. 39, when an image of the customer 302 is input from outside of the checkout assistance system 101, the image pickup device 201 and the image pickup device 206 can be omitted. When the candidate generation process is performed outside the checkout assistance system 101, the feature amount information storage unit 202, the identification information setting unit 203, the identification unit 204 and the storage unit 205 can be omitted.

In the checkout assistance system 101 illustrated in FIG. 23, when the identification information of the cart 303 is input from outside of the checkout assistance system 101, the receiver 2301 and the receiver 2302 can be omitted. In the checkout assistance system 101 illustrated in FIG. 39, when the flow line generation process is performed outside the checkout assistance system 101, the flow line generation unit 3901 can be omitted.

The configurations of the self-checkout system illustrated in FIG. 3, FIG. 4, FIG. 24, FIG. 29, FIG. 32, FIG. 33 and FIG. 40 are just examples, and some of the constituents may be omitted or changed in accordance with the purposes or conditions of the self-checkout system. For example, in the self-checkout system illustrated in FIG. 3, FIG. 24 and FIG. 40, candidate information may be transferred to the checkout apparatus 314 by using the mobile terminal 2902 instead of the server 313 similarly to the configurations illustrated in FIG. 29 and FIG. 32.

In the self-checkout system illustrated in FIG. 29 and FIG. 32, candidate information may be transferred to the checkout apparatus 314 by using the server 313 instead of the mobile terminal 2902 similarly to the configurations illustrated in FIG. 3, FIG. 24 and FIG. 40.

In the self-checkout system illustrated in FIG. 24, FIG. 29 and FIG. 32, the receiver 2301, the receiver 2302 and the transmitter 2401 may be omitted so that the shopping ID setting process and the shopping ID identification process are performed by using a feature vector of the face of the customer 302, similarly to the configuration illustrated in FIG. 3.

In the self-checkout system illustrated in FIG. 3, the receiver 2301, the receiver 2302, and the transmitter 2401 may be added so that the shopping ID setting process and the shopping ID identification process are performed by using the identification information of the cart 303, similarly to the configurations illustrated in FIG. 24, FIG. 29 and FIG. 32.

In the self-checkout system illustrated in FIG. 3, FIG. 24, FIG. 29 and FIG. 32, the monitor camera 4001 and the monitor camera 4002 may be added so that the shopping ID setting process and the shopping ID identification process are performed by using a flow line of the customer 302, similarly to the configuration illustrated in FIG. 40.

In the self-checkout system illustrated in FIG. 24 and FIG. 40, the checkout target identification process may be performed on the basis of whether or not a target of gaze of the customer 302 shifted from an item to the cart 303, similarly to the configuration illustrated in FIG. 3. In the self-checkout system illustrated in FIG. 29, the camera 2901 may be omitted so that the checkout target identification process is performed on the basis of whether or not a target of gaze of the customer 302 shifted from an item to the cart 303, similarly to the configuration illustrated in FIG. 3. In the self-checkout system illustrated in FIG. 32, the measurement instrument 3201 may be omitted so that the checkout target identification process is performed on the basis of whether or not the target of gaze of the customer 302 shifted from an item to the cart 303, similarly to the configuration illustrated in FIG. 3.

In the self-checkout system illustrated in FIG. 24, FIG. 29, FIG. 32 and FIG. 40, the checkout target identification process may be performed on the basis of whether or not a target of gaze is fixed to the same item for a prescribed period of time, similarly to the configuration illustrated in FIG. 3.

In the self-checkout system illustrated in FIG. 3, the checkout target identification process may be performed on the basis of whether or not the angle of convergence of the customer 302 increased by a prescribed angle or more, similarly to the configurations illustrated in FIG. 24 and FIG. 40. In the self-checkout system illustrated in FIG. 29, the camera 2901 may be omitted so that the checkout target identification process is performed on the basis of whether or not the angle of convergence of the customer 302 increased by a prescribed angle or more, similarly to the configurations illustrated in FIG. 24 and FIG. 40. In the self-checkout system illustrated in FIG. 32, the measurement instrument 3201 may be omitted so that the checkout target identification process is performed on the basis of whether or not the angle of convergence of the customer 302 increased by a prescribed angle or more, similarly to the configuration illustrated in FIG. 3.

In the self-checkout system illustrated in FIG. 3, FIG. 24 and FIG. 40, the measurement instrument 3201 may be added so that the checkout target identification process is performed on the basis of whether or not the total amount of the items in the cart 303 increased, similarly to the configuration illustrated in FIG. 32. In the self-checkout system illustrated in FIG. 29, the camera 2901 may be omitted so that the checkout target identification process is performed on the basis of whether or not the total amount of the items in the cart 303 increased, similarly to the configuration illustrated in FIG. 32.

In the self-checkout system illustrated in FIG. 32, a checkout process may be performed in which item names are displayed in accordance with an order of rearranged records of candidate information, similarly to the configurations illustrated in FIG. 3, FIG. 24, FIG. 29 and FIG. 40. In the self-checkout system illustrated in FIG. 3, FIG. 24, FIG. 29 and FIG. 40, a checkout process may be performed in which an item name is displayed by extracting a record of candidate information including an item that is close to an exterior feature of an item on the measurement stand 323, similarly to the configuration illustrated in FIG. 32.

The various pieces of information described in FIG. 5 through FIG. 12, FIG. 25, FIG. 30, FIG. 34, FIG. 37, FIG. 41 and FIG. 42 are just examples, and various pieces of information in formats different from them may be used. The checkout screen illustrated in FIG. 13 is just an example, and a checkout screen in a format different from it may be used. The xyz coordinate system illustrated in FIG. 3, FIG. 24, FIG. 29, FIG. 32 and FIG. 40 are just examples, and a different three-dimensional coordinate system may be used.

The flowcharts illustrated in FIG. 14 through FIG. 22, FIG. 26 through FIG. 28, FIG. 31, FIG. 35, FIG. 36, FIG. 38 and FIG. 43 through FIG. 45 are just examples, and some of the processes may be omitted or changed in accordance with the configurations or conditions of the self-checkout system.

For example, in step 1703 in FIG. 17, it is also possible to detect the direction of the face of the customer 302 from an image instead of detecting the line of sight of the customer 302 from an image and detect the gaze position on the basis of the detected direction of the face. Step 2702 in FIG. 27, step 3102 in FIG. 31, step 3502 in FIG. 35 and step 3804 in FIG. 38 may also be changed similarly to step 1703.

The processes in step 2205 and step 2210 in FIG. 22 and the processes in step 3607 and step 3612 in FIG. 36 may be omitted. When a record of the item information 222 in FIG. 11 includes a price for one piece of item instead of a price per unit weight of item, the processes in step 2204 and step 3606 may further be omitted.

The checkout assistance system 101 illustrated in FIG. 1, FIG. 2, FIG. 23 and FIG. 39 may be applied not only to a self-checkout system but also to a checkout system in which a store clerk manipulates a POS register to select an item as a checkout target.

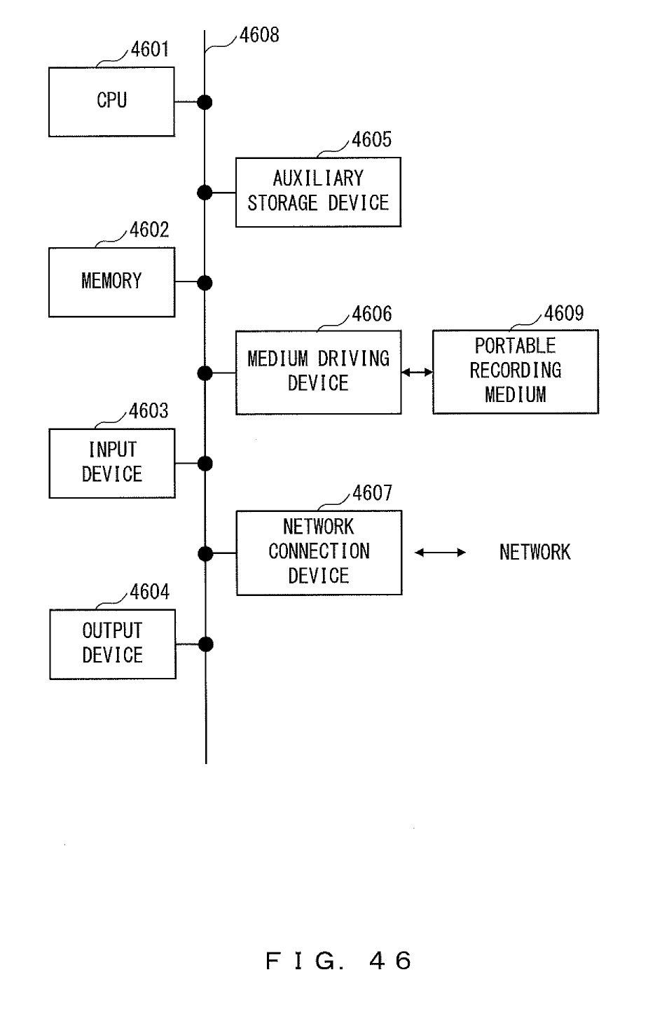

The process device 312 and the checkout apparatus 314 illustrated in FIG. 3, FIG. 24, FIG. 29, FIG. 32 and FIG. 40, the server 313 illustrated in FIG. 3, FIG. 24 and FIG. 40 and the mobile terminal 2902 illustrated in FIG. 29 and FIG. 32 may be implemented by using for example an information processing apparatus (computer) as illustrated in FIG. 46.

The information processing apparatus illustrated in FIG. 46 includes a Central Processing Unit (CPU) 4601, a memory 4602, an input device 4603, an output device 4604, an auxiliary storage device 4605, a medium driving device 4606, and a network connection device 4607. These constituents are connected to each other via a bus 4608.

When the information processing apparatus is the process device 312, the camera 311, the receiver 2301, the camera 2901 and the communication device 2903 may be connected to the bus 4608. When the information processing apparatus is the checkout apparatus 314, the camera 321, the receiver 2302 and the communication device 2904 may be connected to the bus 4608. When the information processing apparatus is the server 313, the monitor camera 4001 and the monitor camera 4002 may be connected to the network connection device 4607 via a communication network.

The memory 4602 is for example a semiconductor memory such as a Read Only Memory (ROM), a Random Access Memory (RAM), a flash memory, etc., and stores a program and data used for processes. The memory 4602 can be used as the candidate information storage unit 111, the feature amount information storage unit 202, the storage unit 205, the storage unit 207 or the flow line information storage unit 3902.

The CPU 4601 (processor) executes a program by using for example the memory 4602 so as to operate as the checkout process unit 112, the identification information setting unit 203, the identification unit 204 or the flow line generation unit 3901.

The input device 4603 is for example a keyboard, a pointing device, etc., and is used for inputting an instruction or information from an operator or a user. The output device 4604 is for example a display device, a printer, a speaker, etc., and is used for outputting an inquiry to the operator or the user or for outputting a process result. When the information processing apparatus is the checkout apparatus 314, the process result may be a checkout screen.

The auxiliary storage device 4605 is for example a magnetic disk device, an optical disk device, a magneto-optical disk device, a tape device, etc. The auxiliary storage device 4605 may be a hard disk drive or a flash memory. The information processing apparatus can store a program and data in the auxiliary storage device 4605 beforehand so as to load them onto the memory 4602 and use them. The auxiliary storage device 4605 may be used as the candidate information storage unit 111, the feature amount information storage unit 202, the storage unit 205, the storage unit 207 or the flow line information storage unit 3902.

The medium driving device 4606 drives a portable recording medium 4609 and accesses information recorded in it. The portable recording medium 4609 is a memory device, a flexible disk, an optical disk, a magneto-optical disk, etc. The portable recording medium 4609 may be a Compact Disk Read Only Memory (CD-ROM), a Digital Versatile Disk (DVD), a Universal Serial Bus (USB) memory, etc. The operator or the user can store a program and data in the portable recording medium. 4609 so as to load them onto the memory 4602 and use them.

As described above, a computer-readable recording medium that stores a program and data used for the processes is a physical (non-transitory) recording medium such as the memory 4602, the auxiliary storage device 4605 or the portable recording medium 4609.

The network connection device 4607 is a communication interface that is connected to a communication network such as a Local Area Network, a Wide Area Network, etc. and that performs data conversion accompanying communications. The information processing apparatus can receive a program and data from an external device via the network connection device 4607, load them onto the memory 4602, and use them.

When the information processing apparatus is the process device 312 or the checkout apparatus 314, the information processing apparatus can communicate with the server 313 via the network connection device 4607. When the information processing apparatus is the server 313, the information processing apparatus can communicate with the process device 312, the checkout apparatus 314, the monitor camera 4001 and the monitor camera 4002 via the network connection device 4607. When the information processing apparatus is the mobile terminal 2902, the information processing apparatus can communicate with the communication device 2903 and the communication device 2904 via the network connection device 4607.

Note that it is not necessary for the information processing apparatus to include all the constituents illustrated in FIG. 46, and some of the constituents can be omitted in accordance with the purposes or conditions. For example, when the information processing apparatus is the process device 312 or the server 313, the input device 4603 and the output device 4604 can be omitted. When the portable recording medium 4609 is not used, the medium driving device 4606 can be omitted.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A checkout assistance system comprising:
a camera;
a processor configured to detect a direction of a line of sight from an image picked up by the camera, refer to position information of an item stored in a memory, and identify one or a plurality of items that correspond to the detected direction of the line of sight; and
a display configured to display the one or the plurality of items identified by the processor in such a manner that the one or the plurality of items can be selected as an item candidate for a checkout target.

2. A checkout assistance system comprising:
a first memory configured to store an item and identification information in association with each other, the item being identified on the basis of a gaze position of a customer detected from an image picked up by a camera in a store from among a plurality of items sold in the store and the identification information being for a checkout for the customer;
a first processor configured to refer to the first memory on the basis of the identification information and extract the identified item when the checkout is to be performed for the customer; and
a display configured to display information of the item extracted by the first processor in a state in which the information of the item can be selected as a checkout target.

3. The checkout assistance system according to claim 2, further comprising:
a second memory configured to store each of the plurality of items sold in the store and a position of each of the plurality of items sold in the store in association with each other; and
a second processor configured to detect the gaze position from the image and identify an item that the customer selected as a purchase target, on the basis of a result of a comparison between the gaze position and information stored in the second memory, wherein
the first memory stores the item identified by the second processor and the identification information in association with each other.

4. The checkout assistance system according to claim 3, wherein
the gaze position is a gaze position of the customer at first time, and
the second processor identifies the item that the customer selected as the purchase target, on the basis of the result of the comparison between the gaze position at the first time and the information stored in the second memory and on the basis of a result of a comparison between a gaze position of the customer at second time and a position of a carrying tool, the second time being within a prescribed period of time from the first time and the carrying tool being a tool that carries the item that the customer selected as the purchase target.

5. The checkout assistance system according to claim 3, wherein
the gaze position is a gaze position of the customer at first time, and
the second processor identifies the item that the customer selected as the purchase target, on the basis of the result of the comparison between the gaze position and the information stored in the second memory and on the basis of a result of a comparison between a first angle of convergence of both eyes of the customer at the first time and a second angle of convergence of the both eyes at second time which is within a prescribed period of time from the first time.

6. The checkout assistance system according to claim 3, wherein
the second processor identifies the item that the customer selected as the purchase target, on the basis of the result of the comparison between the gaze position and the information stored in the second memory and on the basis of a movement of a hand of the customer detected from an in-store video of the store.

7. The checkout assistance system according to claim 3, wherein
the gaze position is a gaze position of the customer at first time, and the second processor identifies the item that the customer selected as the purchase target, on the basis of the result of the comparison between the gaze position and the information stored in the second memory and on the basis of a change in a weight of items that the customer selected as purchase targets, the change being at second time which is within a prescribed period of time from the first time.

8. The checkout assistance system according to claim 7, wherein
when a total weight, at the second time, of items that the customer selected as purchase targets is greater than a total weight, at the first time or time earlier than the first time, of items that the customer selected as purchase targets, the second processor identifies the item identified on the basis of the gaze position of the customer as the item that the customer selected as the purchase target.

9. The checkout assistance system according to claim 8, wherein
when a total weight, at third time, which is later than the second time, of items that the customer selected as purchase targets is smaller than the total weight at the second time, the second processor deletes, from the first memory, information including the item identified on the basis of the gaze position of the customer.

10. The checkout assistance system according to claim 3, further comprising
a third processor configured to set identification information received from a carrying tool that carries the item that the customer selected as the purchase target, as the identification information for the checkout for the customer.

11. The checkout assistance system according to claim 3, further comprising:
a third memory configured to store feature amount information, which associates a plurality of feature amounts of a plurality of humans with a plurality of pieces of identification information, the plurality of feature amounts being extracted from a plurality of images picked up by a plurality of cameras in the store and each of the plurality of pieces of the identification information being for a checkout for each of the plurality of humans; and
a third processor configured to make the first memory store a piece of identification information associated with a feature amount of the customer by the feature amount information, as the identification information for the checkout for the customer.

12. The checkout assistance system according to claim 3, further comprising:
a third memory configured to store flow line information, which associates a plurality of pieces of identification information of a plurality of mobile objects detected from an in-store video of the store and a plurality of flow lines of the plurality of mobile objects; and
a third processor configured to make the first memory store a piece of identification information associated, by the flow line information, with a flow line existing within a prescribed distance from the camera, as the identification information for the checkout for the customer.

13. The checkout assistance system according to claim 12, wherein
the third processor makes the first memory store a piece of identification information representing a group of two or more mobile objects from among the plurality of mobile objects, as the identification information for the checkout for the customer.

14. The checkout assistance system according to claim 3, wherein
the second processor detects a line of sight of the customer or a direction of a face of the customer from the image, and detects the gaze position on the basis of the line of sight or the direction of the face.

15. A non-transitory computer-readable recording medium having stored therein a program that causes a computer to execute a process comprising:
extracting, from a memory that stores an item identified on the basis of a gaze position of a customer detected from an image picked up by a camera in a store from among items sold in the store and identification information for a checkout for the customer, the identified item on the basis of the identification information when the checkout for the customer is to be performed; and
displaying information of an extracted item in a state in which the information of the extracted item can be selected as a checkout target.

16. A checkout assistance method comprising:
extracting, by using a processor and from a memory that stores an item identified on the basis of a gaze position of a customer detected from an image picked up by a camera in a store from among items sold in the store and identification information for a checkout for the customer, the identified item on the basis of the identification information when the checkout for the customer is to be performed; and
displaying, by using the processor, information of an extracted item in a state in which the information of the extracted item can be selected as a checkout target.
